(19) United States
(12) Patent Application Publication
(10) Pub. No.: US 2010/0028543 A1
(43) Pub. Date: Feb. 4, 2010

(54) Inorganic Nanocylinders in Liquid Crystalline Form

(75) Inventors: Virginia A. Davis, Auburn, AL (US); Shanthi Murali, Austin, AL (US); Bennett Marshall, Opelika, AL (US)

Correspondence Address: ANDRUS, SCEALES, STARKE & SAWALL, LLP, 100 EAST WISCONSIN AVENUE, SUITE 1100, MILWAUKEE, WI, 53202, US

(73) Assignee: Auburn University, Auburn, AL (US)

(21) Appl. No.: 12/261,867

(22) Filed: Oct. 30, 2008

Related U.S. Application Data
(60) Provisional application No. 61/000,937, filed on Oct. 30, 2007.

(51) Int. Cl. B05D 3/02; C09K 19/06; B05D 3/00

(52) U.S. Cl. 427/372.2; 252/299.01; 427/331

(57) ABSTRACT

Disclosed are compositions that include a dispersion of inorganic nanocylinders in lyotropic liquid crystalline form. The inorganic nanocylinders have a high aspect ratio and are highly aligned.

### STATEMENT REGARDING FEDERALLY SPONSORED RESEARCH OR DEVELOPMENT

This invention was made with U.S. Government Support from the following agencies: National Science Foundation division of Civil, Mechanical, and Manufacturing Innovation (NSF—CMMI) Grant No. 0707981. The U.S. Government has certain rights in the invention.

### CROSS-REFERENCE TO RELATED APPLICATION

The present application claims the benefit of priority under 35 U.S.C. §119(e) to U.S. provisional application No. 61/000,937, filed on Oct. 30, 2007, the content of which is incorporated herein by reference in its entirety.

### BACKGROUND

The present invention relates generally to nanotechnology. In particular, the invention relates to assembly of inorganic, cylinder-like nanomaterials referred to as nanocylinders, nanorods, nanotubes, nanowhiskers, or nanowires in compositions.

Nanotechnology involves creation or manipulation of materials either by scaling up single atoms (bottom up) or by reducing bulk materials (top down). Its infrastructure is made of colloidal science, standard physical models, statistical mechanics, supramolecular chemistry, chemical, material and electrical engineering. William Illsey Atkinson in his book ‘Nanocosm,’ (Atkinson 2004) wrote, “all technology is nanotechnology because of the fact that each one of them relies on the properties of matter at a very small scale.” In the foreword for this book, Richard E. Smalley, Nobel Laureate and a pioneer nanotechnologist, stated that nanotechnology is comprised of fundamental intellectual aspects relevant to society. Nanotechnology has applications ranging from rocket science to tennis racquets. Carbon nanotubes have the potential to replace the entire copper wire grids of this country and spiral carbon nanotubes can be used as memory storage devices (Baughman, Zakhidov et al., 2002). Nanoparticles have aided the enhancement of drug delivery, cancer research (Mazzola 2003), catalysis (Johnson 2003), cosmetics (Müller, Radtke et al., 2002), in situ bioremediation and water treatment (Christian, Von der Kammer et al., 2008). Inorganic nanowires have significant potential for the further miniaturization of electronic circuits, biomedical sensors and optoelectronics (Y. Xia, Yang et al., 2003). Nanocomposites have greatly increased the strength of materials and are used widely in fuels cells, batteries, transducers, coatings (Loeffler 2005). Thus, successive laboratory experiments have pushed nanotechnology from scientific interest to macro-scale industrial applications. One of the exciting new frontiers in nanotechnology is found at its intersection with liquid crystalline science.

Liquid crystals, discovered in 1888 by an Austrian botanist, Friedrich Reinitzer, are an intermediate phase between a solid and a liquid phase. They consist of ordered species in a solvent; the mesogens or building blocks of the liquid crystalline phase can be organic or inorganic, biological or synthetic. The seminal theories of Onsager (1949) and Flory (1956) established that for hard rods, the transition of isotropic liquid into a liquid crystalline phase results from the balance between steric repulsion and entropy driven forces; it is a function of the length to diameter ratio (aspect ratio). Mineral liquid crystals, where the mesogens of the liquid crystalline phases are all inorganic, belong to the field of colloidal science, with its roots in 1915 (Sonin 1998). In spite of the early discovery of the first inorganic liquid crystals, almost all of the liquid crystalline phases that have been characterized in the last fifty years were “rod-like” organic polymers. The knowledge obtained from polymer liquid crystals and the development of numerous synthesis techniques of anisotropic metal nanoparticles is responsible for the revival of interest mineral liquid crystals research.

“Nanowires, nanorods or nanowhiskers. It doesn't matter what you call them, they are the hottest property of nanotechnology,” states the heading of a news feature on inorganic nanorods in Nature (Appell 2002). Cylindrical rigid rod-like materials such as nanowires and nanorods vary in their aspect ratio and find innumerable potential commercial applications in opto-electronic and biomedical devices. The term “rigid rods” refers to stiff molecules, whose persistence length to length ratio is at least 10, and which are more likely to form liquid crystalline phases (Larson 1999; Davis 2006). Both inorganic nanorods and individual single-walled carbon nanotubes are categorized as rigid rods. Anisotropic assemblies of these one dimensional nanostructures in liquid phase have been achieved by research groups in the last ten years (Davidson and Gabriel 2005; Zakri and Poulin 2006). However, fundamental understanding and comprehensive characterization of lyotropic rigid rod liquid crystals is still in infancy. High yield nanorod synthesis and uniform stable dispersions are critical criteria indispensable for achieving lyotropic liquid crystalline phases. Since meeting these two criteria is a great challenge, there have been only a handful of reports on carbon nanotube and inorganic nanorod liquid crystals. Here, we disclose liquid crystalline mesophases of inorganic nanorods and characterize both the dispersed rods in the liquid phase and the processed dispersion into aligned coatings.

### SUMMARY

Disclosed are compositions that include a dispersion of aligned inorganic nanocylinders in lyotropic liquid crystalline form. The compositions may be utilized to prepare films and coatings, which may be freestanding or may be present on solid substrates.

The disclosed compositions include inorganic nanocylinders (i.e., non-carbon nanocylinders). Suitable inorganic materials include metals and metalloids. Suitable inorganic nanocylinders for the compositions include, but are not limited to, silver nanocylinders and germanium nanocylinders.

In the disclosed compositions, the inorganic nanocylinders are in lyotropic liquid crystalline form. Preferably, in the disclosed compositions at least about 5% of the inorganic nanocylinders are in liquid crystalline form (more preferably at least about 10%, 20%, 30%, 40%, 50%, 60%, 70%, 80%, 90%, or 95% of the inorganic nanocylinders are in liquid crystalline form).

The inorganic nanocylinders of the disclosed compositions typically have a suitable aspect ratio with respect to persistent length versus diameter. In some embodiments, inorganic nanocylinders of the disclosed compositions have an aspect ratio of at least about 5 (preferably at least about 10, more preferably at least about 50, even more preferably at least about 100, and even more preferably at least about 500).

The inorganic nanocylinders of the disclosed compositions typically have an average diameter of less than about 100 nm and an average length of at least about 500 nm or at least about 1000 nm. In some embodiments, the inorganic nanocylinders have an average diameter of about 1-100 nm and an average length of about 1-100 microns.

The disclosed compositions of inorganic nanocylinders may include films, coatings, or fibers, which may be freestanding or may be present on solid substrates. In some embodiments, films or coatings may be prepared by a method that includes: (a) forming a dispersion of the inorganic nanocylinders in a solvent (e.g., at a suitable concentration for forming a lyotropic liquid crystalline phase); (b) placing the dispersion on the solid substrate; (c) applying a shear force to the dispersion thereby aligning the inorganic nanocylinders; and (d) removing the solvent (e.g., by drying, heating, or evaporating the solvent). Suitable inorganic nanocylinders and solvents for forming the dispersion include silver nanocylinders dispersed in an aqueous solvent (e.g., an aqueous solution that comprises surfactant or a biomolecule). Other suitable inorganic nanocylinders and solvents for forming the dispersion include silver nanocylinders dispersed in a polyol solvent (e.g., ethylene glycol or propylene glycol). Even other suitable inorganic nanocylinders and solvents for forming the dispersion include germanium nanocylinder dispersed in an alcohol (e.g., methanol, propanol, or isopropanol) or in chloroform. In some embodiments, sufficient shear force is applied such that the inorganic nanocylinders exhibit banding. Optionally, the methods may include drying the solvent (e.g., by applying heat or allowing evaporation under ambient conditions).

Optionally, the methods for preparing films or coatings may include synthesizing the inorganic nanocylinders prior to forming a dispersion of the inorganic nanocylinder in a solvent. In some embodiments, a dispersion of silver nanocylinders in a polyol solvent may be prepared by mixing a silver salt in a polyol solvent and heating the mixture (e.g., by microwaving). Optionally, nanocylinder forms may be separated from nanosphere forms by centrifugation.

### BRIEF DESCRIPTION OF THE FIGURES

FIG. 1 is a schematic representation of self assembly and shear alignment.

FIG. 2 illustrates separation in the centrifuge tube after centrifugation of nanotube and nanospheres.

FIG. 3 is a schematic representation of Friedelian classes.

FIG. 4 illustrates phase behavior of rods in a solvent as understood in the art.

FIG. 5 is a schematic representation of a phase diagram as understood in the art.

FIG. 6 is a plot of concentration against free energy (left) and a phase diagram according to Onsager theory (right) which shows narrow biphasic region and discontinuity when the volume fraction approaches unity as understood in the art.

FIG. 7 illustrates the subdivision of a lattice which is the basis for Flory's equations (left) and the phase diagram of Flory theory (right) as understood in the art.

FIG. 8 illustrates shear bands in dried films of 15% PBLG+dioxane at high shear rate as observed in the art.

FIG. 9 is a schematic flow diagram of synthesis of silver nanorods.

FIG. 10 is a schematic of shear alignment.

FIG. 11 provides scanning electron micrographs of silver nanorods synthesized by the wet chemical synthesis technique. a) As synthesized nanorod dispersion. This dispersion upon centrifugation resulted in b) self-assembled structures on a silicon substrate c) numerous self assembled domains with no common director d) formation of branched patterns all over the substrate.

FIG. 12(a) Color change in nanorod dispersion on heating in the microwave at different stages at a time span of 0-210 seconds. (Bottom) TEM micrographs of silver nanorods synthesized by polyol reduction technique: (b) The as-synthesized nanorods showed slight alignment in drop dried samples. Image also shows the presence of spherical nanoparticles (c) Aqueous silver nanorods dispersion after being washed with acetone.

FIG. 13 (Left) Length distribution and (right) diameter distribution of silver nanorods, measurement made on 110 nanorods showed an average length of 6 mm and diameter of 60 nm leading to aspect ratio of 100.

FIG. 14 illustrates optical microscopy images showing the difference between (a) sidewall portion and (b) bottom portion of the centrifuged residue. Imaged by Nikon Eclipse 80i microscope with 20× DIC NA 0.24 objective and 2× magnification in front of the camera.

FIG. 15 illustrates an isopycnic centrifugation of a silver nanorod dispersion.

FIG. 16 provides a UV-Vis spectra of silver nanorods (left) showing broader peak for purified nanorods, narrower peak for sedimented nanoparticles and a sharp peak for aqueous silver nitrate. The calibration curve at 389 nm for silver nanorods in aqueous medium plotted with a slope of 0.098 (right).

FIG. 17 provides an SEM image showing that aligned regions of rods are seen at the top, and the nanoparticles settle down below the rods.

FIG. 18 provides optical microscopy images: a) Unsheared samples exhibiting birefringence taken on the 20× DIC 0.45 objective with 2× in front of the camera; and b) presence of tactoids in the sediment of as synthesized nanorod dispersion, taken on the 60× DIC, 1.4 oil immersion objective with 2× in front of the camera.

FIG. 19 illustrates silver nanorods strands observed in a sample in flat capillary tube (left) with 20× DIC 0.45 objective with 2× in front of the camera. SWNTs spaghetti (right) in 102% sulftiric acid as reported in the art.

FIG. 20 illustrates a Schlieren structure typical of a nematic phase in a) silver nanorod in Ethylene glycol and b) SWNT in superacid.

FIG. 21 is a plot of differential scanning calorimetry data of silver nanorods in ethylene glycol.

FIG. 22 is a plot showing a decrease in enthalpy with increasing nanorod rod volume fraction.

FIG. 23 provides optical microscopy images of shear alignment of nanorods in (left) ethylene glycol and (right) in water.

FIG. 24 illustrates shear aligned silver nanorods in ethylene glycol exhibiting birefringence. Samples were taken near the meniscus at 0° and at 45° relative to the polarizer.

FIG. 25 illustrates shear banding in sample that is rotated 0°, 45°, 90° and 135° with respect to polarizer axis on an optical microscope as observed for lyotropic liquid crystalline polymers.

FIG. 26 illustrates the structure of Poly (vinyl pyrollidone) (PVP).

FIG. 27 illustrates FT-Raman spectra of silver nanorods synthesized by polyol reduction and pure PVP (left) as understood in the art, and schematic of PVP conformation on silver nanorod surface (right).

FIG. 28 illustrates polarization dependence of Raman spectra at various angles with respect to the electric field vector.

FIG. 29 illustrates Petri dishes that were inoculated with 10⁷ and 10⁹ CFU/ml E. coli and incubated with silver nanorods, silver nanoparticles, and control samples of Ethylene glycol (EG) and PVP-EG.

FIG. 30 illustrates that areas supplemented with (Left) silver nanorods and (Right) silver nanoparticles are clear of bacteria in Petri dishes.

### DETAILED DESCRIPTION

The disclosed subject matter is further described below.

Unless otherwise specified or indicated by context, the terms “a”, “an”, and “the” mean “one or more.”

As used herein, “about”, “approximately,” “substantially,” and “significantly” will be understood by persons of ordinary skill in the art and will vary to some extent on the context in which they are used. If there are uses of the term which are not clear to persons of ordinary skill in the art given the context in which it is used, “about” and “approximately” will mean plus or minus ≦10% of the particular term and “substantially” and “significantly” will mean plus or minus >10% of the particular term.

As used herein, the terms “include” and “including” have the same meaning as the terms “comprise” and “comprising.”

The disclosed compositions include “inorganic nanocylinders.” “Nanocylinders” alternately may be referred to herein as “nanorods,” “nanowhiskers,” “nanowires,” or “nanotubes.” Inorganic nanocylinders as contemplated herein have a relatively high aspect ratio with respect to average length (L) versus average diameter (D). In some embodiments, inorganic nanocylinders as contemplated herein have an aspect ratio that is at least about 5 (preferably at least about 10, 20, 50, 100, 500, or even 1000).

Inorganic nanocylinders as contemplated herein typically have an average diameter (D) that is less than 100 nm and an average length (L) that is at least about 500 nm or 1000 nm. In some embodiments, inorganic nanocylinders as utilized in the composition disclosed herein may have an average diameter of about 1-100 nm (or about 10-100 nm or about 20-100 nm, or about 50-100 nm) and an average length of about 0.5-100 microns (or about 1-100 microns, 2-10 microns, or 2.5-7.5 microns).

The disclosed compositions include inorganic nanocylinders. Suitable inorganic material for the nanocylinders of the disclosed compositions includes, but is not limited to, metals and metalloids. Suitable metals include silver, iron, cobalt, nickel, copper, gold, chromium, manganese, titanium, vanadium, platinum, tungsten, and the like. Suitable metalloids include, but are not limited to, germanium, silicon, boron, and the like.

The disclosed compositions include aligned inorganic nanocylinders. The alignment and uniform dispersion of the inorganic nanocylinders within the disclosed compositions may be quantified by Raman spectroscopy as shown herein (e.g., by calculating the Raman alignment ratio G⁰/G⁹⁰) or as understood in the art, for example, using the Fraser fraction, f where f=(R−1)/(R+4), and R, the alignment ratio, is the Raman intensity ratio between the parallel and perpendicular orientations of the nanotube aggregates. (See, e.g., U.S. Pat. No. 7,125,502, which content is incorporated herein by reference in its entirety). In some embodiments, the Raman alignment ratio for inorganic nanocylinders of the disclosed compositions is at least about 5 (or at least about 6 or at least about 7).

The disclosed compositions include inorganic nanocylinder in liquid crystal form. Although there have been numerous reports of organic liquid crystals, very few inorganic liquid crystalline compositions have been reported. Furthermore, the presently disclosed compositions include dispersions of inorganic nanocylinder liquid crystals having a high aspect ratio (L/D). The inorganic nanocylinders utilized in the compositions disclosed herein have distinct properties as compared to carbon nanotubes. These distinct properties may be attributed at least to their combination of rigidity and high length to diameter ratio, their polydispersity in length and diameter, attractive interactions between rods, and their high density with respect to the solvent used to form a dispersion of the inorganic nanocylinders. In addition, the high aspect ratios (e.g., where the nanocylinders have diameters up to tens of nanometers and lengths up to ten microns) result in the thermodynamically preferred monodomian structure being inaccessible due to the long relaxation time of the rods and potential for structural jamming.

The presently disclosed compositions may be prepared by applying shear to a dispersion of inorganic nanocylinders. As disclosed herein, shear may be applied to compositions that comprise these inorganic nanocylinders to create films and coatings with different morphologies. The present disclosure is believed to be the first report in which: (1) uniform alignment and distribution of high aspect ratio inorganic nanocylinders was achieved in a film/coating through the combination of liquid crystalline self assembly and flow alignment; (2) controlled concentration bands (shear bands) were observed; 3) segregation of nanocylinders and spheres was achieved with nanocylinders in high concentration bands and the spheres in between the bands (which may impact manufacturing methods in which nanocylinder and spheres may be comprised of different material); (4) different directions of alignment in different planes in a single processing step was achieved.

Fluid phase processing is desirable for the hierarchical bottoms-up assembly of anisotropic nanomaterials for use in applications and functional devices such as transistors, macroelectronic devices, sensor, electro-optical devices, and structural material. For these applications and devices, the ultimate goal is controlled distribution of the rods and controlled alignment. The present disclosure is believed to be the first report in which a combination of self-assembly and flow alignment was used to produce structures with controlled morphologies from high aspect ratio inorganic nanocylinder dispersions. As such, the disclosed compositions may be utilized for numerous applications and devices. In particular, the disclosed compositions may be utilized in device fabrication and electronics, particularly flexible electronics coated on a substrate. Furthermore, the disclosed compositions may be utilized in electro-optical devices, micro-scale sensors, and anti-microbial coatings.

### Examples

The following EXAMPLE 1 and EXAMPLE 2 are illustrative and are not intended to limit the scope of the claimed subject matter.

### Example 1

### Silver Nanorods in Liquid Crystalline Form

Reference is made to Shanthi Murali, Masters Thesis Defense entitled “Coupled Self-Assembly and Flow Alignment of Silver Nanorods,” Jul. 28, 2008, Department of Chemical Engineering, Auburn University, the content of which is incorporated herein by reference in its entirety.

1.1 Abstract

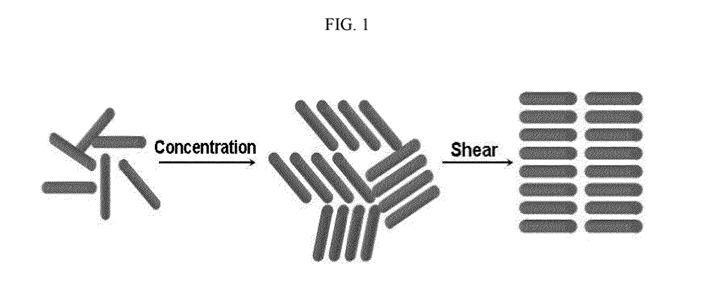

Silver nanorods were synthesized by literature methods (Caswell, Bender et al. 2003; Gou, Chipara et al. 2007). The dispersion phase behavior for both the as synthesized rods and those obtained after rinsing, centrifugation and nanosphere removal was investigated. Transitions from the isotropic to the biphasic region were observed with increasing the nanorod concentration. Phase transitions were evaluated using optical microscopy and differential scanning calorimetry. The liquid crystalline domains were investigated in detail by optical microscopy and different morphologies such as strands and tactoids were studied. Macro-scale coatings were produced by applying shear to the samples resulting in uniformly aligned films. The schematic representation of self-assembly and shear alignment is shown in FIG. 1. Shear banding, a remarkable shear induced phenomena, was also observed and characterized. Preliminary Theological experiments were done to understand the phase behavior. Antibacterial activity was checked for the samples of silver nanorods in the gram negative bacteria, Escherichia coli.

Background

2.1 Rod-Like Nanomaterials

One-dimensional nanostructures such as wires, rods, belts and tubes are gaining increasing recognition for their potential importance in materials research. This is attributed to the fact that the shape of these structures determines their material properties. As a result, nanotubes and nanorods have outstanding thermal, chemical, electronic, photonic and plasmonic properties compared to their bulk counterparts (Buhro and Colvin 2003). Nanorods are usually referred to as materials having their width in nanometers and an aspect ratio less than 20 (aspect ratio is defined as the ratio of length of the major axis to the width of the minor axis, for a nanorod, it is the length to diameter ratio); nanostructures with aspect ratio greater than 20 are termed as nanowires (Murphy and Jana 2002). However, herein, nanorods, nanowires, and nanocylinders are alternately referred to as “nanorods,” as fundamental thermodynamics and physics stems from scientific understanding of rods in solution.

2.2 Synthesis of Inorganic Nanorods

The field of solid state chemistry has witnessed an evolution with regard to synthesis techniques for anisotropic materials. Most of the high temperature solid state syntheses have been replaced by low temperature solution chemistry (Davidson, Batail et al. 1997). This “bottom-up” approach for nanorod synthesis is performed by applying one of the following strategies: size reduction of large one dimensional nanostructures, self-assembly of zero dimensional nanostructures, templated growth, introduction of a capping agent in the synthesis medium, reduction of symmetry of the seed, usage of intrinsically one-dimensional crystalline structure or supersaturation control to modify the seed growth (Y. Xia, Yang et al. 2003).

2.2.1 Silver Nanorods—Synthesis and Applications

Synthesis Techniques

Noble metals are widely synthesized by techniques such as templated synthesis (using hard or soft templates), synthesis by phase separation, and wet chemical or seed mediated synthesis (Murphy and Jana 2002). Silver nanorods were chosen as the model system in this research to study liquid crystallinity and shear alignment, and are being synthesized by numerous approaches. Hard templated growth of silver nanorods was achieved using mesoporous silica (Han, Kim et al. 2000) and carbon nanotubes (Ajayan and Iijima 1993); whereas, the soft templates used include polymers (Sun, Yin et al. 2002; Sun and Xia 2002) and surfactant micelles (El-Sayed 2001). Of equal importance were the seeded and seedless wet chemical synthetic methods of silver nanorods (Lin, Yue et al. 2001). Electrochemical deposition (Zhu, Liu et al. 2000) and green synthesis techniques (hydrolysis) (Wang, Liu et al. 2004; Nadagouda and Varma 2008) were some of recent approaches applied for large scale silver nanorod synthesis. All these techniques aim at the formation of silver nanoparticles that grow into rods by the process of Ostwald ripening, a process of formation of rods at the expense of the particles (Boistelle and Astier 1988).

Syntheses of both organic and inorganic compounds are sensitive to heating conditions (Mingos and Baghurst 1991). When compared to traditional heating, microwave heating is preferred especially for polymer bound reactions for the synthesis of nanostructures. Microwave heating assists in the fast ramp of temperature in reactions that require rapid heating (Larhed and Hallberg 2001). In wet chemical synthesis techniques, formation of one dimensional inorganic nanostructures demands elevated temperatures and can take 1-10 hours when heating is performed via conventional methods. This can be brought down to a few minutes by heating with microwave irradiation. Initially only inorganic nanoparticles were synthesized by microwave heating. Tsuji et al. achieved the synthesis of noble metal nanorods with this rapid heating process (Tsuji, Hashimoto et al. 2005). In this research, in order to accelerate the polyol reduction reaction, microwave irradiation as described by Gou et al (2007) was used for the synthesis of silver nanorods.

Application of Silver Nanorods

Amongst all metals, bulk silver exhibits the highest electrical and thermal conductivity. Fabrication and study of one dimensional nanostructures of silver have also become the focus of intensive research as silver nanorods and nanowires greatly enhance the existing and potential commercial applications of silver in optical, electronic and sensor devices. The optical properties of silver nanorods enable their use in polarizers (Pang, Meng et al. 2003) and photonic crystals (Hu and Chan 2004). Their anisotropic property is exploited in nanoelectronics (Graff, Wagner et al. 2005) and catalysis (Chimentao, Kirm et al. 2004). The excellent surface enhanced Raman scattering (SERS) (Jeong, Zhang et al. 2004) and surface enhanced fluorescence (SEF) (Aslan, Lakowicz et al. 2005) of silver nanorods enables their use in biomedical and chemical sensors. The fact that the Raman scattering signal significantly increases when the scatterer was placed on a roughened noble metal substrate was established by Jeanmaire and Van Duyne in 1977 (Jeanmaire and Vanduyne 1977). Noble metals are extensively used in sensor applications due to their ability to enhance the inelastic scattering signal (Haynes, Yonzon et al. 2005; Shanmukh, Jones et al. 2006). The shape property of nanorods have made them better candidates for Raman spectroscopy than nanospheres as the local electric field at the end of the nanorods is more than ten times of that experienced by the nanospheres when the both materials are exposed to inelastic scattering of photons (Haynes, McFarland et al. 2005). Aligned silver nanorods therefore serve as sensitive substrate for Surface Enhanced Raman Spectra (SERS).

2.3 Separation of Nanorods and Nanoparticles by Centrifugation

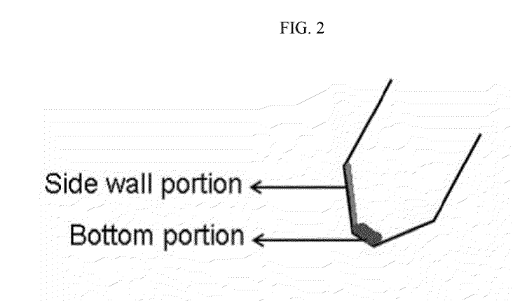

In most cases, inorganic nanorods synthesis is accompanied by the formation of nanoparticles. The separation of the nanorods from the nanoparticles is critical for achieving uniform liquid crystallinity and flow alignment. In our experiments, we used centrifugation, a traditional technique used to separate particles based on size and density. Though complete separation was not achieved, samples having predominantly nanorods were obtained by this method. Also it was found that the portion of residue accumulated at the side wall of the centrifuge tube after centrifugation had mostly nanorods and the residue at the bottom region was predominantly spherical nanoparticles (as shown in FIG. 2). In the following explanation about centrifugal sedimentation, nanorods will be called rods and nanoparticles will be called spheres.

For particles in a dispersion undergoing centrifugation, the following forces are experienced: A centrifugal force F_{c}, a buoyant force F_{b}, a viscous drag F_{d} and a Brownian fluctuating force F_{f}, where,

F_{c}=ω²rm

F_{b}=ω²rm₀

F_{d}=−fᵥ

F_{c}+F_{b}+F_{f}+F_{d}=0 (in steady state)

where, ω is the centrifugation speed in rpm, m is the mass of the particle, m₀ is the mass displaced by the particle, r is the distance from the center to the location of the particle, f is the drag coefficient and v is the sedimentation velocity. The Sedimentation coefficient which is expressed in Svedberg units from the above forces is given as, S=v/ω²r =(m−m₀)/f. The drag on a sphere from Stokes Law is 6 πηαν, where η is the viscosity of the solution and α is the radius of the sphere. (Friction coefficient f=6 πηα). Therefore, the sedimentation coefficient of a sphere is

Sₛₚₕₑᵣₑ=2(ρ−ρₒ)α²/9η

where, ρ and ρ₀ are the density of the sphere and solvent respectively. In contrast, the sedimentation coefficient of a rod is,

$${S}_{rod} = \frac{( ρ - {ρ}_{0} ) {d}^{2} [ 2 ln ( L / d ) - ( {v}_{perpendicular} + {v}_{parallel} ) ]}{24 η}$$

where L/d is the aspect ratio and ν_{perpendicular}, νₚₐᵣₐₗₗₑₗ are the correction factors of the rods perpendicular or parallel to the rod orientation. Their actual values for cylindrical rods are −0.84 and 0.21 respectively. The sedimentation of rods and spheres in a solution mixture containing both of them depends on the ratio of sedimentation coefficients.

S_{rod}/Sₛₚₕₑᵣₑ=6(d/2α)²[2 ln(L/d)−(ν_{perpendicular}+νₚₐᵣₐₗₗₑₗ)]

The above equations show that the diameters of rods and spheres play a very important role in whether the rod or sphere sediments first. When the diameter difference between the sphere and rod is small, then the ratio largely depends on the aspect ratio term and thus rods settle first. If the diameter of the sphere is greater than that of the rod, the sphere is likely to settle first (Heimenz and Rajagopalan 1997).

In systems where the rods assemble in the solution itself, due to aggregation, the rods will gain higher diameter and tend to sediment first and the spheres will be found at the top as observed for gold nanorods (Jana 2003). In systems where the rods are dispersed in the solution without assembling, the above explained scenario of rod-sphere separation takes place during centrifugation (Park 2006).

2.4 Nanorod Self-Assembly and Alignment

Molecular self-assembly is an important phenomenon that governs organization in organic and inorganic structures. Cells assemble to form tissues, amino acids assemble in specific patterns to form various proteins, organic and inorganic nanostructures assemble in order to create complex nanomaterials and larger scale structures. Assembly of nanorods across the micro to macroscale is imperative in order to create functional devices composed of nanoscale building blocks for use in numerous applications. Self-assembly in colloidal dispersions has been achieved for various metallic and semiconductor nanorod systems and for carbon nanotubes. Entropy driven ordering and energetically favored reactions are significant reasons behind self-assembly (Lekkerkerker and Stroobants 1998). Assemblies of nanorods can also be achieved by external forces. Controlled alignment by an external field aids in the formation of uniform assembly on the macroscale. Langmuir-Blodgett is an established method to produce monolayer films of nanoparticles and quantum dots. This technique has been extended to assemble nanorods for integrated nanoelectronic devices (Kim, Kwan et al. 2001; Jin, Whang et al. 2004). Application of an alternating electric field of high intensity and frequency was also found to induce nanorod self-assembly. In this case, the conducting nanorods were placed between microelectrodes, where they were subjected to the external electric field (Cheng, Gonela et al. 2005). Ferromagnetic nanorods such as goethite and nickel nanorods spontaneously assembled when they are placed in an external magnetic field produced by a bar magnet (Tanase, Bauer et al. 2001). More recently, fluidic alignment with surface-patterning technique and large scale alignment by blown film extrusion for both nanorods and nanotubes were described by Lieber group (Huang, Duan et al. 2001; Yu, Cao et al. 2007). Surfactant coated gold nanorods were assembled by addition of adipic acid to the nanorod dispersion. The pH of the system was varied and the pH-dependant assembly was monitored continuously. The nanorods showed no assembly at a pH of 3 and aggregation was initiated when the pH was increased to 7. The solvent was evaporated and the assembled nanorods were characterized by transmission electron microscopy (Orendorff, Hankins et al. 2005). Gold nanorods were also assembled by using genetically engineered M13 bacteriophage as templates (Huang, Chiang et al. 2005). Other assembly techniques includes drop drying, which was reported for the assembly of carbon nanotubes (Duggal, Hussain et al. 2006; Li, Zhu et al. 2006), film casting, which was used to observe the end to end assembly of CdS nanorods (Ghezelbash, Koo et al. 2006), and solution spinning, which was performed to assemble rutile nanorods (Dessombz, Chiche et al. 2007). The primary focus of this research is liquid crystalline assembly and shear alignment of silver nanorods.

2.5 Liquid Crystals

Liquid crystals are an intermediate phase between crystals and isotropic liquids; they possess a unique blend of properties, the order of a crystal and fluidity of a liquid. Therefore, liquid crystalline phases are called as mesophases and the anisotropic building blocks of these phases are called mesogens. Liquid crystals are used in a range of applications. Some of them include opto-electronic devices such as liquid crystalline displays (LCDs), and high strength fibers such as DuPont Kevlar™ which is used in bullet-proof materials.

First observed in esters of cholesterol in 1888 by Friedrich Reinitzer, liquid crystalline science is one the oldest branches of colloidal chemistry. Liquid crystals were published and discussed by Otto Lehmann in 1889 and classified by Friedel in 1922. Following this were the monumental theories on liquid crystallinity by Onsager (1949) and Flory (1956). Various mesogens such as tobacco mosaic virus, rod-like polymers, organic molecules and amphiphilic micelles are all building blocks for liquid crystalline phases, with over 80,000 examples of organic and organometallic compounds characterized to date. However, only about a dozen of these have been completely inorganic (mineral) liquid crystals. The advent of nanotechnology in the last decade started to be a renaissance era for liquid crystalline science with numerous inorganic nanorods and carbon nanotubes developed into anisotropic mesophases.

2.5.1 Classification of Liquid Crystals

Liquid crystalline phases are classified based upon their formation and their molecular arrangement. Thermotropic liquid crystals are formed due to changes in temperature bounded by solid on one end and liquid transition on the other. Small molecules with flexible spacers along the polymer backbone usually form thermotropic liquid crystals.

For example, p-azoxyanisole is a solid below 118.2° C., exhibits a liquid crystalline phase between 118.2° C. and 135.3° C. and melts in to an isotropic liquid above 135.3° C.

In contrast, phase transitions in lyotropic liquid crystals are induced by the changes in the concentration of the mesogens. Lyotropic liquid crystals are made of rigid rod-like macromolecules. For these systems, phase equilibrium is a function of both aspect ratio and solvent; for a given concentration the phase equilibrium can change due to changes in solvent quality. Although solvent quality is often considered to be analogous to temperature, changes in temperature may or may not have a significant effect on the system. This research focuses on the lyotropic phases of rigid silver nanorods.

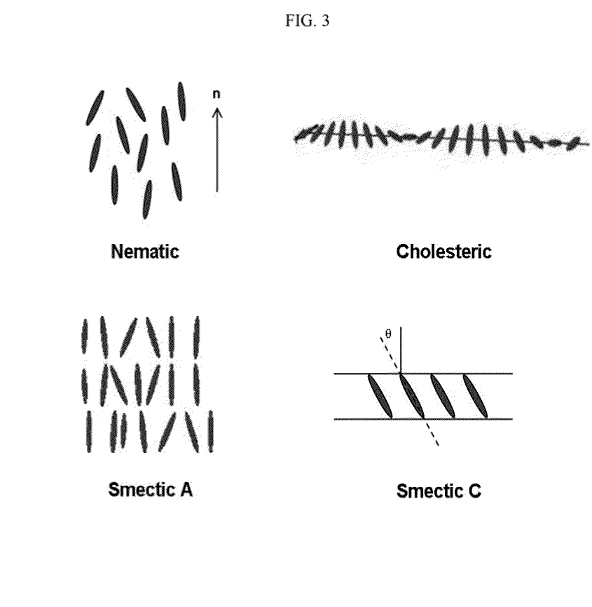

Friedel (1922) published a seminal paper classifying liquid crystals in to three categories based upon their molecular arrangement; these are known as Friedelan classes (FIG. 3). Nematics denote the simplest form of liquid crystals and possess long range orientational order but only short range positional order. Nemata means thread in Greek, the name is given due to the thread like appearance of nematic in a light microscope. The imperfect alignment in nematics is quantified by the order parameter, S, given by,

S=3/2(cos² θ)−1/2

S=0 represents completely random (isotropic) molecular arrangement and S=1 represents perfectly parallel orientation of anisotropic rods.

Cholesteric phases have a similar molecular arrangement to nematics, but have a periodic twist about an axis perpendicular to the director, n. The director is the term for the direction of orientation in a liquid crystal towards which all the molecules are aligned as a whole or in small domains. Another important term with respect to cholesterics is the pitch, p, which is defined as the distance taken by the director to rotate one full turn in the helix. The twist in cholesterics is attributed to the chiral nature of the mesogens. Cholesterics were named based on their arrangement of mesogens and were first observed in esters of cholesterol. These nematic-like twisted phases are also called chiral nematics.

Smectic liquid crystalline phases have their name from Greek word σμεγμα, meaning “soap-like”, as their basic layer structure gives them a soapy feel. Smectics has a molecular arrangement which possesses both long range orientational and positional order. Amphiphiles like soap and detergent molecules form lyotropic smectic phases in solution. Smectic phases exhibit the most perfect arrangement compared to other liquid crystalline phases and have a layered structure. Diameter polydispersity inhibits the formation of smectic phase and favors nematic phase formation to achieve better packing of mesogens. Amongst many types of smectic phases, the two most commonly found types are smectic A and smectic C. Smectic A has molecules arranged with the director lying along the layer normal and there is no correlation between the layers. Smectic C has a director that is inclined at an angle to the layer normal. 2.6 Phase Behavior of Rods

The phase behavior of monodispersed, non-interacting rods in fluids is well known in the art. However, theories for inorganic nanocylinder dispersions are not well-developed. Formation of liquid crystals by rod-like species is governed by entropy. The various concentration regimes of rods are shown in FIG. 3. In the dilute regime, the rods are free to translate and rotate freely and therefore have high orientational and translational entropy. As the concentration of rods increases and enters the semi-dilute regime, the rotation of the rods is inhibited but they retain their translational entropy. The isotropic concentrated phase exists when the concentration is such that rods are confined to straw-like volumes only. Increasing the concentrations causes the rods to phase separate into a biphasic system consisting of an isotropic phase in equilibrium with a liquid crystalline phase. In order to increase the packing efficiency at higher concentrations, parallel alignment is preferred. This considerably reduces the orientational entropy, but the translational entropy becomes higher as the rods can freely translate in the axial direction. After phase transformation into a completely liquid crystalline phase, the loss of orientational entropy due to ordering is more than compensated by the gain in translational entropy. Lyotropic liquid crystalline phase transformation occurs purely due to the increase in the concentration of rigid rods and their aspect ratio. Since temperature does not have a significant influence on such a system, it is therefore called ‘athermal’. The phase diagram for rods in a solvent that are not athermal is described in Section 2.7.

2.7 Phase Diagram of Lyotropic Liquid Crystals

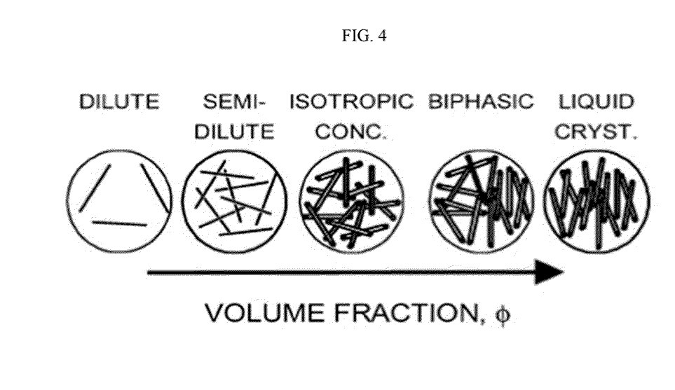

The phase diagram for lyotropic rigid rod liquid crystals is plotted with volume fraction or concentration on the x-axis and temperature, solvent quality or solvent interaction parameter on the y-axis. The generic phase diagram is represented in the FIG. 4. For monodisperse rods in biphasic region, the concentrations in the isotropic and liquid crystalline phases are constant, but the relative amount of each phase increases with increasing total concentration. A broad biphasic region is observed for poor solvent quality and narrows to form a biphasic chimney for systems with favorable solvent quality. This is often thought in terms of the Flory-Huggins interaction parameter K which is positive in the broad biphasic region (poor solvent quality) and either a small positive number or negative in the biphasic chimney (good solvent quality). The reason for this is that, when the solvent interaction parameter is high, the two phases interacts more with the solvent than with each other and tend to be far apart, as the solvent interaction parameter decreases, due to lesser interaction with the solvent, the two phases are very close to each other forming the chimney structure in the phase diagram. Polydispersity also plays an important role in widening the gap of the biphasic region. In a polydisperse rigid rod system, on increasing the concentration, rods that are long tend to align forming the nematic phase and smaller or shorter rods continue to stay at random orientations making up the isotropic phase. These two phases coexist causing the phase gap to remain constant. Flexibility of the mesogen is also affects the phase equilibrium, but is not likely to be a factor in this research.

2.8 Theories of Liquid Crystallinity

The theoretical phase boundaries of lyotropic liquid crystalline systems were proposed by Lars Onsager (1949) and P. J. Flory (1956). Even though both these theories have proponents, applying these models to individual systems is largely based on the mesogen that makes up the liquid crystalline phase. The pioneering work of Onsager is applied to most of the rigid rod system and the lattice model of Flory is usually applied for liquid crystalline polymers with flexible spacer and side chains.

2.8.1 Steric Theory of Rigid Rods

Both Onsager and Flory theory arise from the steric theory of rigid rods which considers the following:
Rods as athermal, that is, the temperature does not have any significant effect on the system. Number of possible arrangements (partition function, Z) is related to entropy as,

S=k_{B} ln Z

where,
S—Entropy
Z—Partition function
kB—Boltzmann Constant
   The points of the theories are:
(1) In a dilute system, rods have a large volume to move around and so parallel orientation is not preferred;
(2) In a concentrated system, the reduction in volume or free space will bring the rods parallel to increase packing efficiency; and
(3) Rods cannot interpenetrate due to presence of excluded volume.

2.8.2 Onsager Approach

Onsager theory (Onsager 1949) laid the theoretical foundation for the liquid crystalline behavior in a rod-like system. This statistical model is based on truncation of the “virial expansion” taking excluded volume into account. When two molecules are next to each other, the excluded volume is defined as the volume in to which the center of mass of one molecule cannot move due to the presence of the adjacent one. Here, this concept is applied for monodisperse spherocylinders here. The Onsager approach assumes a model of perfectly rigid, long, and thin rods (L/D>>1). Non-rigidity as well both long-range attractive and repulsive potentials are neglected. The only force of importance according to Onsager theory is the steric repulsion and that the system is athermal.

Virial Expansion:
The expression (for N identical particles) of the virial expansion for the partition function is given by,

$$\frac{ln Z}{N } = - ln ( η {λ}^{3} ρ ) - \int f ( Ω ) ln [ 4 π f ( Ω ) ] d Ω + \frac{ρ}{2} \int \int f ( Ω ) f ( {Ω}^{′} ) β ( Ω , {Ω}^{′} ) d Ω d {Ω}^{′} + \frac{{ρ}^{2}}{2} \int \int \int f ( Ω ) f ( {Ω}^{′} ) f ( {Ω}^{″} ) β ( Ω , {Ω}^{′} , {Ω}^{″} ) d Ω d {Ω}^{′} d {Ω}^{″} + …$$

where,
η—Includes contributions from angular degrees of freedom

$$λ = \frac{h}{\sqrt{2 π {mk}_{B} T}} - Thermal wavelength$$

Ω—Angular variable that can take any orientation in 3D space
β₁ and β₂—Cluster integrals

The first term in the right hand side is the free energy of the translational motion of the rods, the second term describes the losses in orientational entropy due to liquid crystalline ordering and the third term is the free energy of interaction of the rods in the second virial approximation. Onsager theory truncates the virial expression with the second term along with the substitution of excluded volume for the cluster integral of rods. The resultant expression of the Onsager theory is,

$$\frac{ln Z}{N} = - ln ( η {λ}^{3} ρ ) - \int f ( Ω ) ln [ 4 π f ( Ω ) ] d Ω - \frac{ρ}{2} \int \int f ( Ω ) f ( {Ω}^{′} ) {V}_{excl} ( Ω , {Ω}^{′} ) d Ω d {Ω}^{′}$$

The truncation of the virial equation is valid only for a lyotropic system with the above stated assumptions.

Plot of Free Energy Versus Number Density

The free energy, A, of the solution of rods is plotted against various values of number density, ρ, and local minima of the curves are calculated.

$$A = {Nk}_{B} T [ \begin{matrix}ln ( η {λ}^{3} ρ ) + \int f ( Ω ) ln [ 4 π f ( Ω ) ] d Ω + \\ \frac{ρ}{2} \int \int f ( Ω ) f ( {Ω}^{′} ) {V}_{excl} ( Ω , {Ω}^{′} ) d Ω d {Ω}^{′}\end{matrix} ]$$

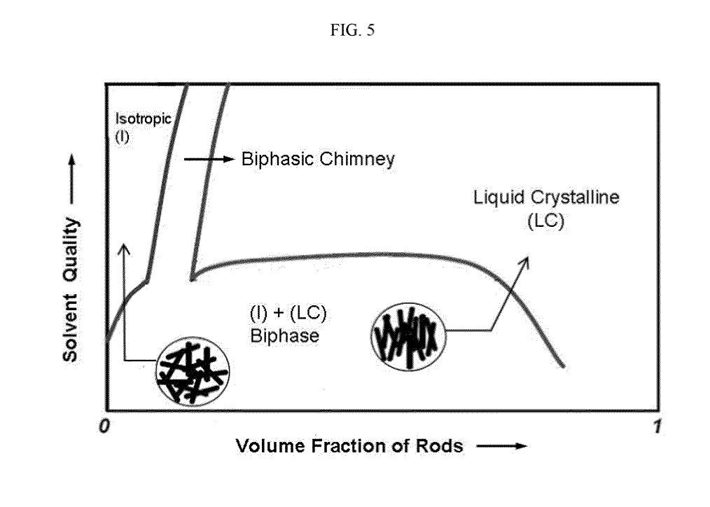

The composition range between the two tangent points, i.e. between ρ_{I} and ρ_{N} (FIG. 5) corresponds to the biphasic region where the isotropic and the nematic phase density coexist. When ρ<ρ_{I}, the system will be completely isotropic and when ρ>ρ_{N}, it will be completely nematic.
By numerical calculations,

$${ρ}_{I} = \frac{4.25}{{DL}^{2}} and {ρ}_{N} = \frac{5.72}{{DL}^{2}}$$

The volume fraction is given by the expression,

$$φ = \frac{ρ ( π {D}^{2} L )}{4}$$

The critical concentration for the transition from the isotropic phase to the biphasic region is,

$${φ}_{I} = \frac{3.34}{( L / D )}$$

The critical concentration for the transition from the biphasic region to the liquid crystalline phase is,

$${φ}_{N} = \frac{4.49}{( L / D )} .$$

2.8.3 Flory Theory

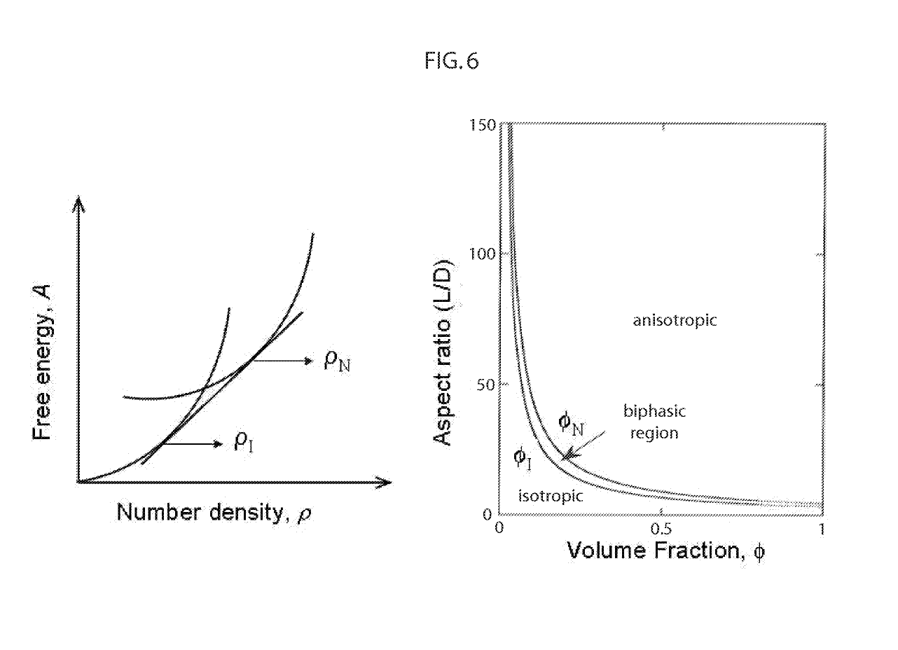

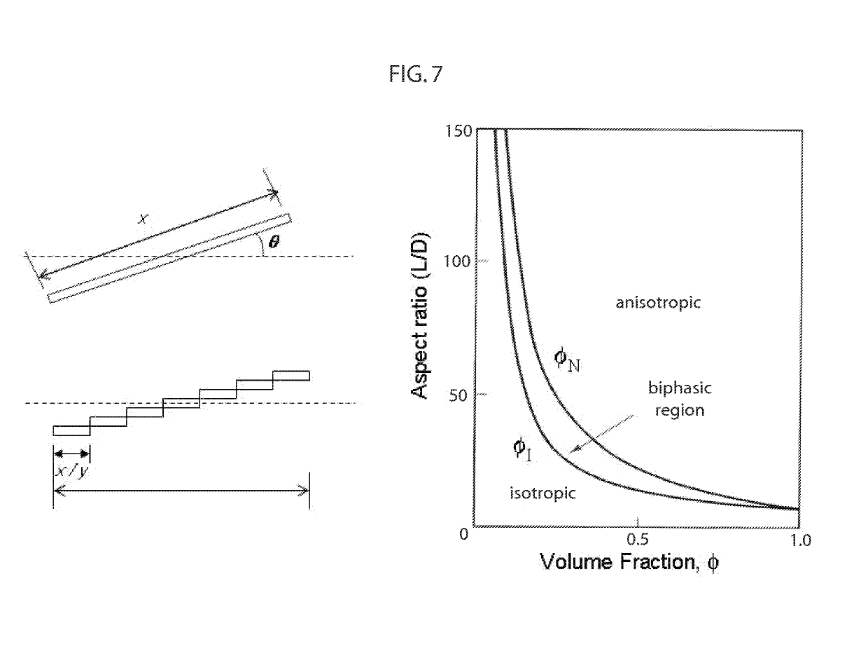

The lattice model (Flory 1956) consists of a system of rigid rods where the net interaction between the solute and the solvent is null. The steric repulsions between the anisotropic particles are considered to be the significant forces for ordering in liquid crystalline phase. The lattice is subdivided in to cubic cells of linear dimension equal to the diameter of particles. Hence, each rod of aspect ratio x is construed to consist of x segments, one segment being accommodated by a cell of lattice as shown in FIG. 6 and FIG. 7. The principal predictions of the Flory theory are the following:
i) Above a critical concentration that depends on the axial ratio x, the system adopts a state of partial order relative to a preferred axis. Below the critical concentration the directions of the particles are completely uncorrelated.
ii) The critical ordering is bridged by the transition phase where the isotropic and nematic phases coexist.
iii) For hard rods of aspect ratio L/D, the phase separation is found to occur in a volume fraction

$$φ = ( \frac{8}{( L / D )} ) ( 1 - \frac{2}{( L / D )} )$$

The critical concentration for the transition from the isotropic phase to the biphasic region is,

$${φ}_{I} = \frac{7.89}{( L / D )} .$$

The critical concentration for the transition from the biphasic region to the liquid crystalline phase is,

$${φ}_{N} = \frac{11.57}{L / D} .$$

Phase diagram according to Flory is continuous for all volume fractions and the order parameter predicted by this model is S=0.92.

2.9 Characteristic of Lyotropic Liquid Crystals

Optical, differential calorimetric and rheological characterizations are the different ways to characterize and confirm liquid crystalline phases.

2.9.1 Optical Characteristics

Birefringence, disclinations and shear banding are important characteristics of liquid crystals observed in optical microscopy under cross polarizers. The optically anisotropic property (propagation of light through the medium depends upon its orientation) of liquid crystals enables them to exhibit birefringence, an essential but insufficient confirmation for liquid crystallinity. Light passing through a uniaxial liquid crystal is split in to two components; a fast ordinary ray and a slow extraordinary ray. The difference in the refractive indices of the two rays results in birefringence. The difference in light intensities observed in a birefringent sample arises due to the phase difference of these two rays as it propagates through the medium. Thus, dark and bright regions appear depending on the director of the liquid crystalline sample is parallel either to the polarizer or analyzer.

Singularities due to point or line defects often occur in liquid crystalline samples. The dislocations were termed by Frank as “disinclinations”, which later on came to be called as disclinations. Nematics have their name from nemata (meaning thread like) are line disclinations, which are dislocations or discontinuities in the director field of a liquid crystal. Schlieren structures which are a characteristic of nematic phase are point singularities and are often used as an identification of mesophase. Described by Friedel as structures a noyaux (noyaux means nuclei), these textures are observed as dark bands or brushes emanating from a single point. These brushes rotate as the cross polarizers are rotated around the point that remains fixed. This is because the brushes are regions where the director is either parallel or perpendicular to the plane of polarization of the incident light and these orientations continuously changes about the disclinations on rotation of cross polarizers. The strength of the disclination is defined as one quarter of number of brushes arising from it. Depending upon whether the brushes rotate in the same or opposite sense as the polars, the strength of the disclinations can be positive or negative. Disclinations in highly rigid rod systems represent much higher elastic constants compared to small molecule liquid crystal systems. Schlieren structures are found very commonly among polymer liquid crystals, and Song et al. studied these structures in detail in the nematic phases of MWNTs. Among early inorganic liquid crystals, the mesophase of aluminium oxyhydroxide sols (Zocher. H and Torok. C 1960) showed areas having typical Schlieren textures with visible disclinations. To date, Lekkerkerer and Alivisatos are the foremost groups to report these textures in nanorod liquid crystals.

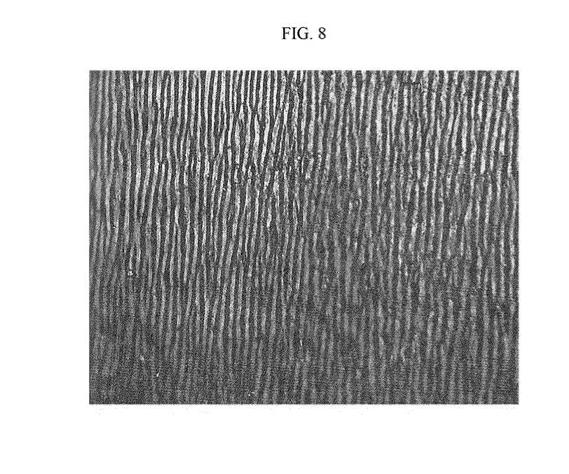

Shear banding, an important shear induced phenomena of phase separation, has been observed in rod like micellar systems along with flow birefringence. Though its exact causes are still controversial, it is usually observed as regions of high and low concentration at uniform intervals and often occurs after the cessation of shear. Banded structures have been reported for sheared samples of both thermotropic and lyotropic polymers and interest in them started when these structures were observed in Kevlar™ (Harrison and Navard 1999). Shear bands have been studied in lyotropics such as poly(γ-benzyl-L-glutamate) (PBG), hydroxypropylcellulose (HPC) and cetyl trimethylammonium bromide (CTAB). They have not previously been reported for inorganic nanorod dispersions. One explanation for shear banding is that it is an annealing-induced improvement in alignment order with a tendency for the constrained specimen to increase in length (buckling of nematics). Also, the band spacing has been noticed to decrease with increasing shear rate. Shear banding has also been explained as being prompted by the negative first normal stress difference in rigid rod lyotropic liquid systems (Fischer, Keller et al., 1996; Kiss and S. Porter 1998) (FIG. 8). Banding is also reported to occur only after the director field is well oriented to the shear plane. This fact will serve as evidence that the shear banded sample was previously aligned. Sometimes, spontaneous banding is observed with disclinations. In this research, we observed that samples that showed shear banding; the nanoparticles were forced out of the high concentration thick silver nanorod bands making the bands to appear brighter. We also observed that rod orientation could be varied in 3-dimensions.

Differential scanning calorimetry provides quantitative analysis for the determination of φ_{N}, the phase transition from the biphasic to the liquid crystalline phase. The thermograms of increasing concentrations of nanorods are marked by a shift in melting point and reduction in enthalpy. Upon transition to a liquid crystalline phase, the dispersion no longer exhibits a melting point. This is due to the fact that the solvent associated with the ordered mesogens also shows partial ordering. In biphasic regions, two types of solvent exist; the free solvent that behaves similarly to pure solvent and shows melting and crystallization peaks and the partially ordered solvent that exhibits thermal properties that are different with the free or the bulk solvent. Upon complete transition in to a liquid crystalline phase, all the solvent present in the dispersion is associated with the mesogens and therefore, there exists no melting peak.

2.10 Types of Lyotropic Liquid Crystals

The earliest reports on lyotropic liquid crystals in inorganic sols date back to 1915, when flow induced birefringence in vanadium pentoxide dispersions (V₂O₅) (Diesselhorst. H, Freundlich. H et al., 1915) was observed. The lyotropic nematic phase of V₂O₅ sols were studied in detail by Zocher and his co-workers (Zocher. H and Torok. C 1962). Initial stages of lyotropic liquid crystal research consisted of inorganic sols of aluminium oxyhyroxide (AlOOH), lithium molybdenoselenite (Li₂Mo₆Se₆), clays like imogolite and montmorrillonite, and anisometric materials such as iron oxyhyroxide and tungstic acid. In his comprehensive review, Sonin exhaustively covered the history and characteristics these early inorganic lyotropic liquid crystalline materials (Sonin 1998). A considerable amount of literature is found on different kinds of mesogens forming liquid crystals such as polymers, molecular wires, discs and ribbons and clays. Assembly of biomolecules into various lyotropic liquid crystalline phases has also been characterized. Rigid dipeptide nanowires have been found to assemble spontaneously at high concentrations in carbon disulfide (CS₂) (T. H. Han, Kim et al., 2007). The phase diagram predicted for this system showed that the isotropic-nematic biphase was found between 0.2 to 7 wt %. Nematic gel or nematic glass transition occurred after 8 wt %. Also, the liquid crystalline domains aligned when an external electric field was applied. Another noteworthy bio-lyotropic phase was achieved by Belcher group (Lee, Wood et al., 2003). Remarkably, a lyotropic liquid crystalline smectic C self supporting cast film was created by this group. As this thesis is on nanorod liquid crystalline assemblies, we confine the discussion on literature only to rigid rod liquid crystals which include carbon nanotubes and inorganic nanorods.

2.10.1 Carbon Nanotube Liquid Crystals

After their discovery by Iijiama in 1991, carbon nanotubes have become one of the most highly researched nanomaterials owing to their exceptional mechanical, thermal, electrical and optical properties (Baughman, Zakhidov et al., 2002; Huang, Chen et al., 2006). Interest in carbon nanotube liquid crystals emerged in 2001 due to the desire to form remarkable macroscopic materials. They are the most studied nanomaterial mesogens. Carbon nanotubes have been predicted to form lyotropic phases by continuum based on density-functional theory within a generalized van der Waals model. The difficulty involved in effective stabilization of dispersions of carbon nanotubes against van der Waals attraction. A few researchers overcame this challenge and have achieved lyotropic liquid crystalline phases with nanotube dispersions.

Pioneering discoveries of lyotropic phases in single walled carbon nanotubes (SWNTs) and multiwalled carbon nanotubes (MWNTs) were made by Davis et al. (2004) and Song et al. (2003) respectively. Protonated SWNTs (Davis, Ericson et al. 2004) dispersed in 102% sulfuric acid self assembled into strand-like domains in the biphasic region and a nematic phase around 4.5 vol %. Characterization of concentrated phases was performed by optical microscopy and rheology and differential scanning calorimetric experiments (Zhou, Fischer et al., 2005). As part of this research, well aligned macroscopic fibers were spun from these ordered phases (Ericson, Fan et al., 2004). It should be noted that the unusual morphologies (strands and tactoids) achieved in the biphasic region with SWNTs in superacids were also observed with dispersions of silver nanorods in ethylene glycol in this research. These interesting morphological structures helped confirm liquid crystallinity in silver nanorod dispersions and aided in understanding their liquid crystalline phase behavior.

Aqueous dispersions of highly oxidized MWNTs (Song, Kinloch et al., 2003) were shown to spontaneously form aligned lyotropic nematogenic phases at high concentration. Schlieren structure observed under optical bireflection for MWNT dispersions is typical of liquid crystals. Such Schlieren structures were also identified in single walled nanotubes embedded in a thermosensitive gel (Islam, Alsayed et al., 2004). Nematic gels were obtained at higher temperatures due to increase in concentration of nanotubes and reduction in the solvent quality of the gel as described by the phase diagram in Section 2.7. Recently SWNTs in narcotic drug γ-butyrolactone were found to form liquid crystalline phases at higher concentrations and were also debundled in the isotropic phase (Bergin, Nicolosi et al., 2007). While the anisotropic phase was characterized by crossed polarized microscopy, the debundling was confirmed by atomic force microscopic studies.

Other than liquid crystallinity in two-phase dispersions of nanotubes and solvents, nanotube dispersions have also been stabilized in biopolymer solutions such as denatured DNA (S. Badaire, Zakri et al., 2005) and biological hyaluronic acid solutions (Moulton, Maugey et al., 2007). Both aqueous dispersions of DNA-SWNT and SWNT-HA were prepared by sonication and phase separation in these bio-nano composites occurred forming birefringent nematic liquid crystals.

2.10.2 Inorganic Nanorod Liquid Crystals

In the last decade, renewed interest in liquid crystals with inorganic moieties has arisen due to improved synthesis methods for inorganic nanorods. Onsager theory laid the foundation for liquid crystal formation by hard spherocylinders. The Lekkerkerker group produced seminal papers on liquid crystalline boehmite nanorods that serve as an excellent model system for Onsager theory (Buining, Philipse et al., 1994; Buitenhuis, Donselaar et al., 1995). The lyotropic phases characterized in the last decade started with the semiconductor nanorod liquid crystals. The Alivisatos group elegantly showed the nematic phase transitions of low aspect ratio CdSe nanorods and have also assembled these phases on a substrate by drop drawing without applied shear (Li, Walda et al., 2002; Li and Alivisatos 2003). Evaporation of the solvent by the incident light of the microscope increased the concentration of CdSe nanorods in cyclohexane leading to the aligned mesophase. The onset of the phase change was marked by the formation of liquid crystalline tactoids, and Schlieren structures were observed at later stages (Li, Marjanska et al., 2004). Around the same time, low polydisperse, surfactant coated gold nanorods in water were reported to self assemble spontaneously forming liquid crystalline phases (Jana, Gearheart et al., 2002). The surfactants coated on gold nanorods rendered them hydrophobic and these nanorods self assembled in order to minimize unfavorable hydrophilic-hydrophobic interactions and interlocking the surfactant tails.

Excellent photocatalytic activity was found to be exhibited by liquid crystalline aqueous rutile nanorods (Dessombz, Chiche et al., 2007). In this seminal work, TiO₂ (rutile) nanorods synthesized by the hydrolysis of TiCl₄ were dispersed in water and displayed a biphasic region between volume fractions of 0.03 to 0.12 under the optical microscope. The order parameter for the nematic phase was estimated to be S=0.75±0.05. Coatings made by aligned mesogenic phases of rutile nanorods showed high photocatalytic activity. Photocatalysis is a promising way for cleaner reactions; liquid crystalline rutile nanorods have great potential in coating for solar panels, self cleaning building materials and antibacterial treatment of air and water.

Another group studied the liquid crystalline phases of TiO₂ nanorods dispersions in organic solvents (Meuer, Oberle et al., 2007). Dispersion of TiO₂ nanorods in organic solvents such as THF and CHCl₃ was achieved by coating pristine nanorods with a diblock copolymer and thus creating what was called as “hairy nanorods.” This system not only showed phase change at high concentrations (lyotropic), the isotropic and nematic phases (schlieren structures) were also identified at various temperature ranges in PEG 400. Thus the solvent quality is tuned with temperature. This group also employed meniscus forces to align the TiO₂ nanorods by slowly drawing the substrate out from the nanorod dispersion.

As discussed in the phase diagram of liquid crystal in Section 2.4, polydispersity in length and diameter inhibits the formation smectic phases in lyotropic liquid crystals. Also, polydispersity widens the biphasic region. Longer rods will orient first while the shorter rods stay in the isotropic phase (Donald, Windle et al., 2005). An exception for this theory was made by the commendable work of Davidson group (Vroege, Thies-Weesie et al., 2006). Highly polydisperse goethite nanorods, not only showed phase transition at 16% volume fraction, but also arranged in to layered smectic phases. These smectic A phases were evident with bright red Bragg reflections in specific directions. Further characterizations of this incredible layered phase were performed by small angle X-ray scattering (SAXS). This revealed sharp first and second order small angle reflection was indicative of smectic ordering. The sample also displayed a transformation of smectic to columnar phase when subjected to magnetic fields above 250 mT. In this sense, polydispersity was proved to be helpful when it was combined with sedimentation, thorough which liquid crystalline phases were achieved (Vroege, Thies-Weesie et al., 2006).

Reports on carbon nanotube and inorganic nanorod liquid crystals are summarized in Table 1 and Table 2.

TABLE 1
Carbon Nanotube Liquid Crystals - Systems where nanotubes form lyotropic phases
and not systems where the nanotubes are incorporated into ordered surfactant or polymer species.
Carbon Nanotube Liquid Crystals

| | Dispersion | Type of | Confirmation of | |
|---|---|---|---|---|
| Mesogens | Medium | Mesophase | Liquid Crystallinity | Literature |
| SWNT | Superacids | Nematic | Birefringence, tactoids, | (Davis, Ericson et al., 2004; |
| | | | Schlieren structure, | Zhou, Fischer et al., 2005) |
| | | | strands, rheology, | |
| | | | SEM, DSC, SAXS | |
| MWNT | Water | Nematic | Birefringence, tactoids, | (Song, Kinloch et al., 2003) |
| | | | Schlieren structure, SEM | |
| Surfactant | N-isopropyl | Nematic | Birefringence, | (Islam, Alsayed et al., 2004) |
| coated SWNT | acrylamide | | Schlieren structure | |
| SWNT | γ-butyrolactone | Nematic | Birefringence, SEM | (Bergin, Nicolosi et al., 2007) |
| SWNT | Mixture of CTAB, | Nematic and hexagonal | Birefringence, | (Scalia, von Buhler et al., 2008) |
| | SDBS and water | columnar phase | SAXS | |

TABLE 2
Inorganic Nanorod Liquid Crystals - Reports of the
few lyotropic phases of inorganic nanorods that have
been discovered in either aqueous or organic solvents.
Inorganic Nanorod Liquid Crystals

| | | | Confirmation | |
|---|---|---|---|---|
| | Dispersion | Type of | of Liquid | |
| Mesogens | Medium | Mesophase | Crystallinity | Literature |
| CdSe | Cyclo- | Nematic | Birefringence, | (Li, Walda et |
| | hexane | | Tactoids, | al., 2002) |
| | | | Schlieren | |
| | | | structure | |
| Gold | Water | Nematic and | TEM | (Jana, |
| | | Smectic | | Gearheart et |
| | | | | al., 2002) |
| Goethite | Water | Nematic and | Birefringence, | (Vroege, |
| | | Smectic and | Tactoids, | Thies-Weesie |
| | | columnar (in | Schlieren | et al., 2006) |
| | | magnetic | structure, | |
| | | field) | SAXS | |
| Rutile | Water | Nematic | Birefringence, | (Dessombz, |
| | | | Tactoids, | Chiche et al., |
| | | | Schlieren | 2007) |
| | | | structure, | |
| | | | SAXS | |
| Polymer | THF, | Nematic and | Birefringence, | (Meuer, |
| Function- | CHCl₃, | Smectic | Schlieren | Oberle et al., |
| alized | PEG | | structure, SEM | 2007) |
| TiO₂ | | | | |

3.1 Synthesis of Silver Nanorods

Silver nanorods were initially synthesized by bench-top wet chemical and later on by microwave assisted synthesis which resulted in higher yield and took less time. The wet chemical synthesis described by Murphy's group (Caswell, Bender et al., 2003) was modified in terms of its concentration of sodium chloride. All glassware used in the experiment was cleaned with aqua regia, a mixture of concentrated nitric acid and concentrated nitric acid in the ratio 1:3. Two boiling solutions, Solution A consisting of 100 ml of deionized H₂O, 40 μl of 0.1M silver nitrate (AgNO₃), 5 ml of 0.01M trisodium acetate, and 3 μl of 1M sodium chloride (NaCl) and Solution B consisting of 100 ml of deionized H₂O, 20 μl of 0.1 M AgNO₃ and 3 μl of 1M NaCl were mixed together. The resulting solution is evaporated to ˜75 ml. This solution gained a shiny greenish yellow appearance after approximately three hours of heating.

Microwave assisted polyol reduction synthesis (Gou, Chipara et al., 2007) was adopted to get a high yield of nanorods in less time. This method was further optimized for better results. Initially for this synthesis, the glassware were cleaned with freshly made piranha solution, but the cleaning was later replaced with deionized water and acetone. Typically, 110 mg polyvinyl pyrrolidone (PVP MW 58000), 90 mg of silver nitrate (AgNO₃) and 5 mg of sodium chloride (NaCl), bought from Sigma Aldrich, were added to 20 ml of ethylene glycol (EG). The resulting mixture was bath sonicated for five minutes in a Cole Parmer bath sonicator to accelerate the dispersion process. The solution changed from colorless to opal after sonication before heating in the microwave. The color change is due to the conversion of silver nitrate to silver chloride as a result of the addition of sodium chloride. The microwave parameters for the reaction were optimized to 300 W and 3.5 minutes. The color of the as synthesized nanorod dispersion was usually light brown and shiny after the microwave heating.

3.2 Characterization

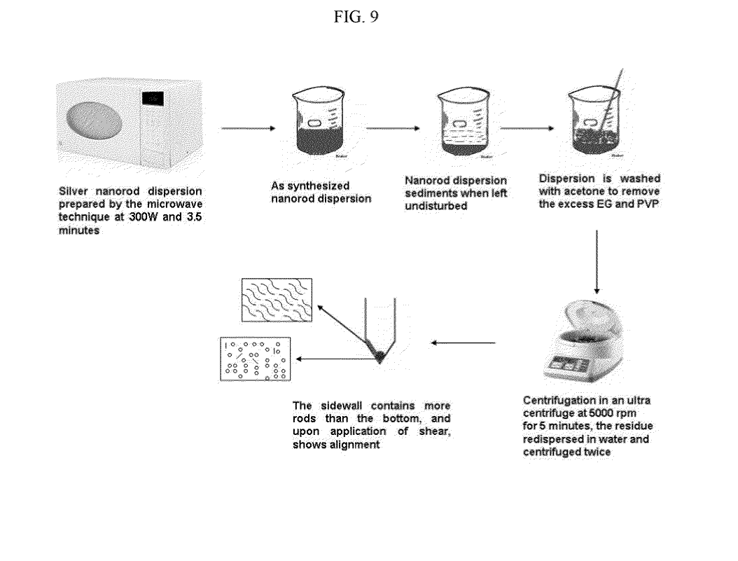

Sedimentation took place when the as-synthesized silver nanorod dispersion was left undisturbed for at least 6 hours. For rod sphere separation and aqueous dispersions, this was stirred up to make it homogeneous. It was first washed with acetone (to remove the excess PVP and EG) and then centrifuged (Cole Parmer ultracentrifuge) at 5000 rpm for five minutes. The supernatant was discarded and residue was redispersed in water and the process was repeated. The residue after centrifugation contained two portions; a side wall accumulation and a bottom portion. The sidewall portion of the centrifuge tube was carefully taken out leaving behind the residue at the bottom portion. This sidewall portion and the sediment of the as-synthesized nanorod dispersion were used for all the characterizations. The process of synthesis and centrifugation is represented in FIG. 9.

Attempts to achieve complete separation of nanorods from nanoparticles were made by gradient centrifugation. This method was carried out by stacking the as synthesized nanorod dispersion on top of a continuous glycerol (Fisher Scientific) gradient. The continuous gradient was made with gradient maker and increased from top to bottom (20% to 80%) of a 30 ml centrifuge tube. Ultracentrifugation was done in Discovery 90 SE ultracentrifuge, in a swinging bucket rotor with parameters 2000×g and 20 minutes. The different layers are pipetted out carefully in to separate vials and characterized by optical microscopy.

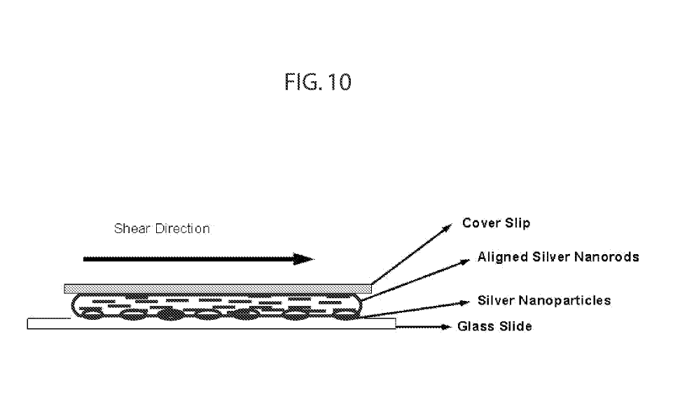

The optical absorption spectrum of silver nanorods was monitored by absorption spectroscopy. UV-Vis spectroscopy was carried out on a Varian 300E spectrophotometer with a 1 cm quartz cuvette. Samples of aqueous silver nitrate and silver nanoparticles were also tested for their absorption spectrum. Qualitative estimation of the concentration of liquid crystalline phase and birefringence were studied by optical microscopy using a Nikon Eclipse 80i Optical Microscope. This was performed for both initial sediment and rinsed centrifugal samples. Samples were imaged in bright and dark field transmission, with and without cross polarizers and differential interference contrast (DIC). 20× and 60× oil immersion objectives were used predominantly for the study with 2× in front of the camera. The sample for optical microscopy was prepared by dropping ˜20 μl of nanorod dispersion on a glass slide (pre-cleaned with acetone) and shearing it with a cover slip as shown in FIG. 10. The edges were sealed to avoid evaporation. Unsheared samples were also studied in detail. Morphological studies were carried out by transmission electron microscopy (TEM) and scanning electron microscopy (SEM). Samples for TEM were prepared by drop drying silver nanorod dispersion on carbon coated copper grids and performed on a Zeiss EM 10 Transmission Electron Microscope. Scanning electron microscopy was carried out in JEOL 7000F FE-SEM with EDX detector after sputter coating the samples with gold. The morphology was also tested using noncontact tapping mode atomic force microscopy (AFM) using a Pacific Nanotechnologies AFM (Santa Clara) apparatus. SEM and AFM were performed on samples drop dried on silicon wafer. Apart from microscopic techniques, alignment was also confirmed by Raman spectroscopy, which was done on clean glass slides were shear coated with nanorod dispersions using a Renishaw in Via Raman Spectrometer. All spectra were collected at 50× magnification using a 514 nm Spectra-Physics air-cooled ion excitation laser. The sample was carefully rotated and imaged at angles (0°, 45°, and 90°) between the incident polarization and axis of nanorod orientation. Multiple accumulations scanning Raman shifts from 600-1800 cm⁻¹ were collected using a 10 second exposure time.

In order to calculate the amount of silver nanorods in dispersions, thermogravimetric analysis (TGA) was carried out using a TA Instruments Q-500 Thermal Gravimetric Analyzer. The sample was heated in clean platinum pans at 5° C. per minute to 500° C. under a constant nitrogen balance protection flow rate of 40 cm³/min and sample air flow rate of 60 cm³/min. The shift and reduction in enthalpy of peaks recorded by differential scanning calorimetry (DSC) proves the presence of ordering of solvent molecules. DSC studies were performed on a TA Instruments Q-2000 in hermitically sealed aluminum pans at a scan rate of 5° C. per minute over a temperature range of −60° to 20° C. with three thermal cycles of heating-cooling-heating.

To test the antibacterial properties of silver nanorods, an agar plate model was developed to investigate Ag nanorod's and nanoparticle's antimicrobial activities, i.e., growth/no growth of the organism under study. Escherichia coli, a gram-negative bacterium was cultivated in a Luria-Bertani (LB) nutrient broth by shaking for 18 h at 37° C. The overnight culture was centrifuged and washed in LB (2×) and resuspended in LB to achieve 106 to 107 CFU/ml. A 100 μl sample of the resuspended culture was plated on a nutrient agar plate. Nanorod dispersions (10 μl) were added to the plates and incubated at 37 C. for 24 h. Negative controls (devoid of nanorods) were studied under identical conditions.

4.1 Synthesis Results

Silver nanorods were synthesized initially by wet chemical synthesis and later the microwave assisted polyol reduction technique was adopted. Most of the studies made in this research were on the nanorods made by the latter technique unless otherwise specified.

4.1.1 Wet Chemical Synthesis

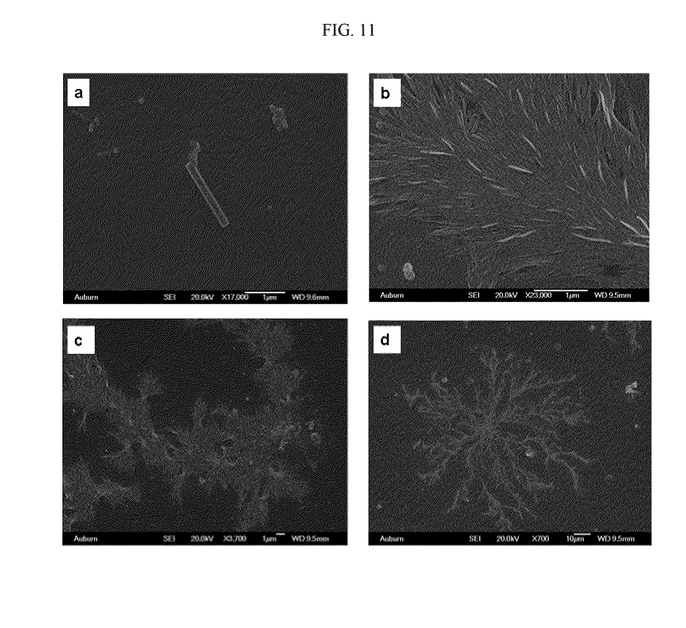

The seedless, surfactantless, wet chemical synthesis of silver nanorods, described by Caswell et al., (2003) was carried out for different amounts of 1M aqueous sodium chloride (NaCl), which was added to the boiling aqueous solutions of silver nitrate and sodium citrate. In this technique, silver nanorods were formed as a result of reduction of silver metal by sodium citrate, which also acts as a capping agent helping the growth of nanorods from nanoparticles. Trial experiments carried out with 1.5-2 μl of 1M NaCl did not produce nanorods even after several repetitions. These samples, when characterized by scanning electron microscopy (SEM), showed only the presence of large amounts of spheres and sodium chloride crystals. Silver nanorods resulted when the amount of 1M NaCl solution was increased to 3 μl. The dispersion was centrifuged at 5000 rpm for 15 minutes. Both the supernatant and the residue were characterized. The supernatant did not show any rods that could be identified in the SEM. About 20 μl of the silver yellow residue from the centrifuge tube was drop dried on a silicon wafer with a surface that was made hydrophilic by piranha treatment. This sample exhibited numerous self assembled micron long aligned domains as shown in FIG. 11. Within each domain, rods appeared to be oriented and closely packed. Surprisingly, there were absolutely no visible spherical nanoparticles in the entire 1.5×1 cm silicon wafer. However, the difficulty in repeating and reproducing the synthesis and assembly prevented further characterization of this extremely interesting result. Synthesis trials made with 4 and 5 μl of NaCl resulted in longer rods accompanied with spherical nanoparticles. After theses experimental trials it was concluded that this technique had disadvantages such as low yield of nanorods per batch and longer reaction time. Therefore, other synthesis schemes were explored to overcome the above mentioned difficulties.

4.1.2 Microwave Assisted Synthesis

Polyol reduction process is an established technique to synthesize silver and gold nanostructures (Sun and Xia 2002; Tsuji, Hashimoto et al., 2005). The microwave assisted polyol reduction synthesis described by Gou et al. (2007) proved to be a route to fast synthesis of silver nanorods. The reaction involves reduction of silver ion to metallic silver by ethylene glycol at elevated temperature more than 100° C. The reduction mechanism is given by,

CH₂OH—CH₂OH→CH₃CHO+H₂O

2Ag⁺+2CH₃CHO→2Ag⁰+2CH₃COCOCH₃+H⁺

Polyvinyl pyrrolidone (PVP) acts as a capping agent and aids the one dimensional growth of nanorod from nanoparticle. PVP is generally used as a soft template in the synthesis of noble metals. In this reaction, it is to be noted that the concentration of the PVP was too low for it to function as a soft template, and therefore it assists in the nanorod growth. The power of the microwave was varied from 100 W to 500 W; nanorod formation was optimized at 300 W. The reaction time was also optimized to 3.5 minutes. This was much less time compared to traditional heating, which can take hours. The short reaction time is due to the conversion of microwave energy in to heat inside the material resulting in rapid localized heating. Longer reaction time resulted in breaking of rods in to particles and was therefore not preferred. It was noticed that the commercial microwave oven used in this procedure switched on and off when the power was set to be 300 W. This was actually the magnetron of the microwave oven, that gets switched on and off in duty cycles of several seconds at a time. This technique was identified to be a fast and efficient technique to synthesize high yields to give high of silver nanorods. The drawback to this method is that it makes many spherical particles as well. The comparison between wet chemical and polyol reduction synthesis techniques is given in Table 3.

TABLE 3
Comparison of silver nanorod synthesis methods

| | Wet Chemical | Polyol Reduction |
|---|---|---|
| Criteria | Synthesis | Synthesis |
| Described by | Caswell et al. (2003) | Gou et al. (2007) |
| Chemicals required | AgNO₃, NaCl, Sodium | AgNO₃, NaCl, PVP |
| | Citrate | |
| Solvent | Water | Ethylene Glycol |
| Heating source | Oil bath heated by | Microwave irradiation |
| | hot plate | |
| Time for reaction | 3 to 4 hours | 3 minutes |
| Initial temperature of | 20° C. | 20° C |
| the reaction mixture | | |
| Final temperature of | 125° C. | 158° C. |
| the nanorod dispersion | | |
| Silver nanorod and | Less than 1 mg | Approx. 160 mg |
| nanoparticle yield | | |
| per batch | | |
| Presence of spherical | Small amounts of | Large amounts of |
| nanoparticles | spherical | spherical nanoparticles |
| | nanoparticles | |
| Cleaning of glassware | Aqua regia | Regular washing and |
| | | rinsing with acetone |
| Reproducibility | Not easily | Same or similar results |
| | reproducible | obtained in every trial |

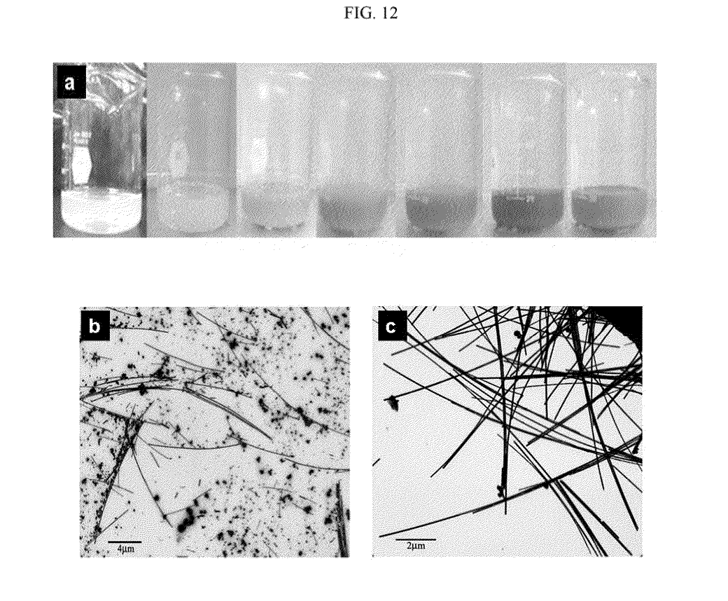

The color changes observed in the reaction mixture during the polyol reduction process, in a time span of 30-210 seconds were very close to the literature results of Gou et al. (2007). The nanorod dispersion after synthesis was allowed to cool for 2 minutes. The shiny appearance of the nanorod dispersion provided immediate qualitative confirmation of the nanorod synthesis. The dispersion was then centrifuged with acetone to remove the excess PVP and ethylene glycol and was dispersed in water. These results are shown in FIG. 12.

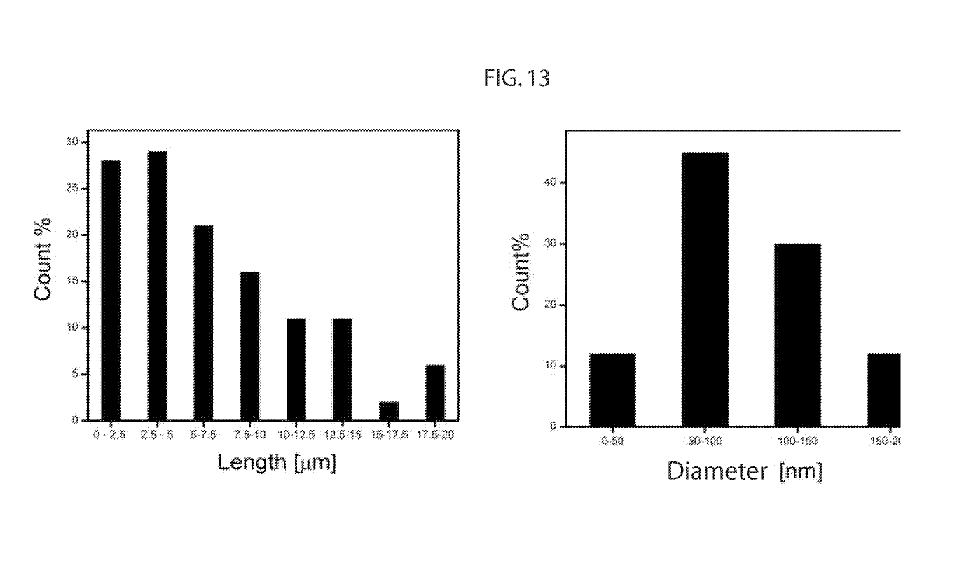

The as synthesized nanorods after sedimentation were also characterized. They were quite polydisperse in both length and diameter and were accompanied by a significant number of spherical nanoparticles. Measurements made on 110 nanorods by TEM indicated an average length of 6 μm and diameter of 60 nm corresponding to an aspect ratio of 100. Some of the rods were as along as 14 microns. The distribution of length and diameter is given in FIG. 13.

4.2 Rod-Sphere Separation

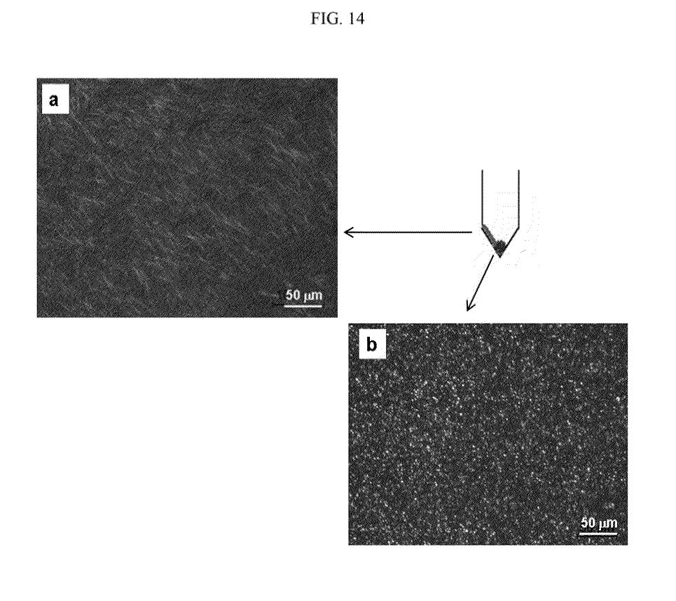

The rod sphere separation (purification) of the nanorod dispersion was carried out in an ultracentrifuge with a fixed angle ultracentrifuge as described in the Experimental Section 3.2. Fixed angle rotors are designed to withstand very high ‘g’ forces and allow for pellet formation. This method led to the partial separation of nanorods from nanoparticles; 0.5 ml of nanorod dispersion was centrifuged with 1 ml of deionized water in a 2ml centrifuge tube. Centrifugation parameters were optimized as 5000 rpm and 5 minutes. Higher centrifugation speeds resulted in all the rods and particles sedimenting at the same region at the bottom of the tube, whereas lower centrifugation speeds did not create any concentration gradient. The supernatant was discarded and the 1.5 ml of deionized water was added. The tube was then shaken vigorously on a vortex shaker for a few seconds and the centrifugation process was repeated. After discarding the supernatant at the end of the water centrifugations, a small portion of the residue, called the pellet, was found near the sidewall of the centrifuge tube. Pellets are formed when the particles slide down after hitting the side wall of the tube due to centrifugal force. They thus get sedimented partly at the sidewall and the rest at the bottom of the centrifuge tube. The sidewall portion of the pellet was carefully taken out with a micropipette and examined in both optical and transmission electron microscopes. This portion of the residue consisted of more rods than particles. The bottom most portion of the residue had a vast majority of particles as shown in FIG. 14. This was likely due to the relative sedimentation behavior of colloidal rods and spheres as determined by their aspect ratio (Section 2.3).

4.3 Isopycnic Centrifugation

Though centrifugation in a fixed angle rotor separated rods from spheres to a large extent, complete separation and large quantities of separated products were not achieved by this method. It was necessary to devise other types of centrifugation in parallel to get better separation of rods from spheres. Density gradient centrifugations are commonly used for purifying subcellular organelles and macromolecules. Isopycnic centrifugation is one classification of density gradient centrifugation where separation of particles occurs based on their density. Either a continuous gradient, where the gradient concentration increases uniformly from to top to bottom of the tube or a discontinuous gradient, where the concentration increases in steps was preferred depending on the particle size to be separated. During gradient centrifugation, the particles are centrifuged through the density gradient and move until their density is the same as that of the surrounding medium. Isopycnic centrifugation was successfully used for separating gold nanorods from nanospheres which were synthesized by surfactant soft template method from nanospheres (Alekseeva, Bogatyrev et al., 2005). Separation of carbon nanotubes based on their diameter, band gap and electronic type have also been reported by density-gradient ultracentrifugation (Arnold, Green et al., 2006).

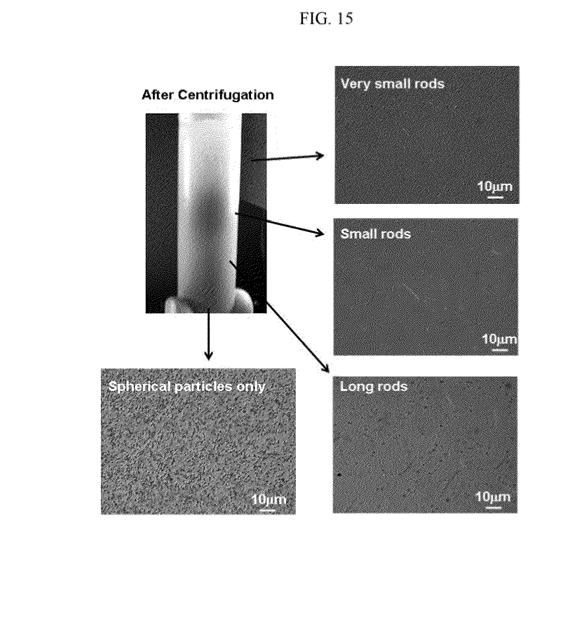

For the separation of silver nanorods from nanoparticles, preliminary studies of isopycnic centrifugation with glycerol as the gradient medium were performed; 5 ml of 0.5 wt % of silver nanorod dispersion in ethylene glycol was stacked on top of a continuous gradient of glycerol (20% to 80%) in a 30 ml centrifuge tube. Without disturbing the gradient, the tubes were sealed and centrifuged at 2000×g and 20 minutes. After centrifugation, different colored bands were noticed in the tube by visual observation as shown in FIG. 15. These bands were pipetted out for characterization by optical microscopy. Size separation of the nanorods was observed at different levels of the centrifuge tube with the short rods at the top most layer and only spherical nanoparticles at the bottom most layer. Spherical nanoparticles were absent in the two top layers but were found in minority in the successive layers. The variables involved in this experiment were concentration of the gradient, speed and time of centrifugation. Effective separation may be possible by optimization of these variables.

4.4 UV-Vis Absorption Spectroscopy

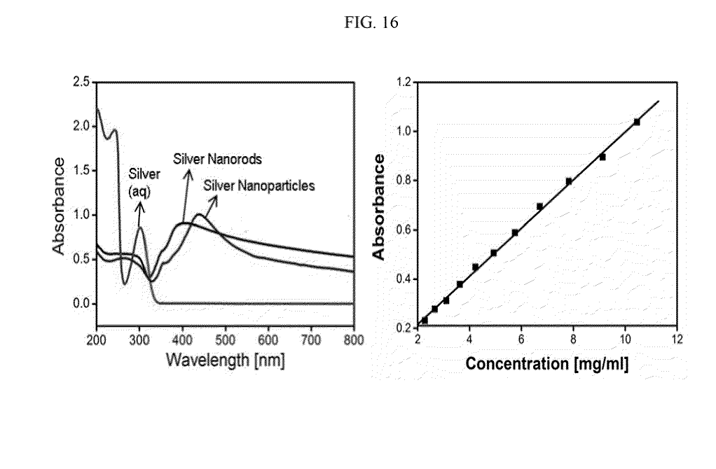

It is well established that UV-Vis absorption spectroscopy is quite sensitive to the analysis of silver nanoparticles because the position of their plasma absorption peak depends on the particle size and shape (Mulvaney 1996). As shown in FIG. 16, aqueous silver nitrate had a sharp peak at 300 nm, purified nanorods resulted in a broad peak (λₘₐₓ at 389 nm) and spherical silver nanoparticles resulted in a comparatively narrow peak (λₘₐₓ at 438 nm) (Liu, Chang et al., 2004). Samples of silver nanorods dispersions were made with decreasing concentration by the method of serial dilution starting with a nanorod concentration of 12 mg/ml. A calibration curve at 389 nm was plotted from the purified nanorods which gave an extinction coefficient of 0.098 (R²=0.99) as shown in FIG. 16.

4.5 Liquid Crystalline Phase of Silver Nanorods

Liquid crystallinity resulting from increasing concentration due to sedimentation is a technique that has been studied in several inorganic sols (Dessombz, Chiche et al., 2007; T. H. Han, Kim et al., 2007). The time taken for the mesogens to sediment has varied from several days to months. Onset of liquid crystalline domains was identified in the as synthesized silver nanorod dispersions when the sample was allowed to sediment overnight. Qualitative estimation of liquid crystallinity was performed by optical microscopy.

4.5.1 Optical Microscopy

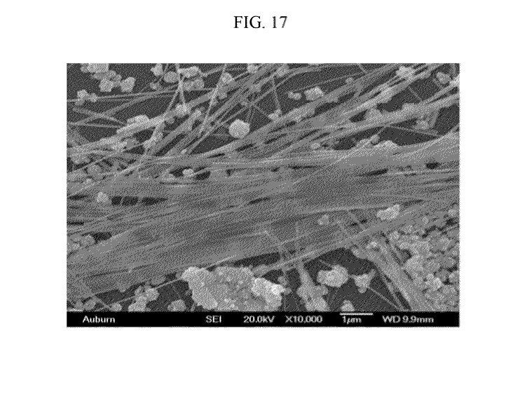

The microscopy samples were prepared by dropping 20 μl of the dispersion on a clean glass slide and sealing it with a coverslip. It was identified that in the sample between the glass slide and the coverslip, the spherical nanoparticles tend to settle down at the bottom with the rods at the top. This agrees with the centrifugation results where the spheres settled down first and the rods settled on top of them. It was also evident in drop dried samples characterized by SEM shown in FIG. 17, where nanoparticles are visible behind assembled rods. Optical microscopy samples were made from the grayish brown sedimented portion of the as synthesized nanorod dispersion. This was highly birefringent when the sample is rotated with respect to the polarization vector of light, similar to a nematic liquid crystal. Birefringence was not witnessed for the light colored top portion of the dispersion. To confirm self assembly careful slide preparation was used so that the samples were unsheared except for wetting forces. Interesting morphologies such as tactoids and strands were also observed in the anisotropic phase of silver nanorods starting from 1.5 wt % dispersions.

4.5.2 Tactoids and Strands

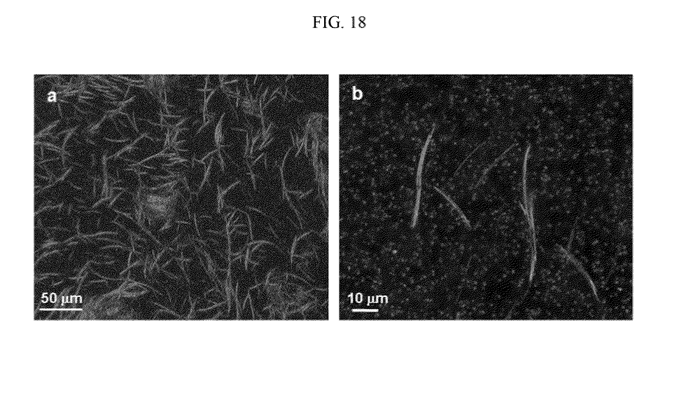

Tactoids are a spindle-like shape that has a larger center diameter and are tapered at the ends. The nematic liquid crystalline phases of rod-like polymer solutions and inorganic sols such as V2O5 often have either a globular or a tactoid shape. Tactoid shapes also occur due to nucleation of solid colloidal particles. In SWNT-superacid dispersions tactoids resulted from the deprotonation of SWNTs upon the addition of moisture (Davis 2006). These tactoid shapes were found to be crystal solvates and not liquid crystals. A crystal solvate is a crystal structure containing entrapped solvent; unlike a liquid crystal it can not rearrange (its structure cannot flow) (Donald, Windle et al., 2005). Birefringent tactoids were observed in the sedimented Ag-EG dispersions (FIG. 18). It is not clear whether these Ag-EG tactoids were a crystal solvate or a nematic phase.

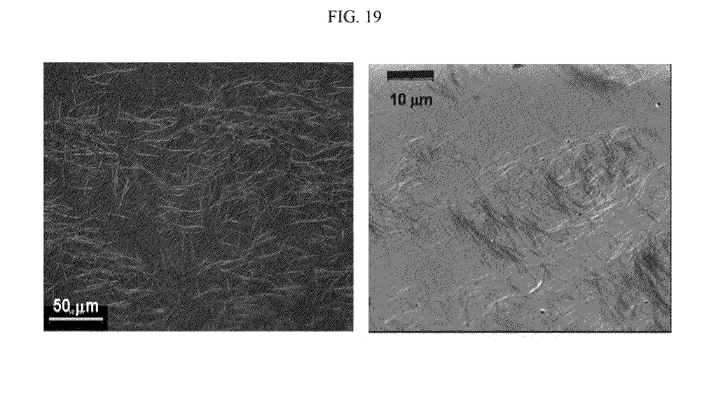

Birefringent self-assembled micron long strands were also observed in biphasic Ag-EG dispersions. The strands were observed in flat capillary tubes (of dimensions 0.5×2.0 mm) and were characterized by optical microscopy. Imaging successive z-planes enabled finding that these stands extended over multiple planes and had no clear ends. It is possible that these strands can only form in the unconfined environment of the capillary tube compared to microscopy slides where the gap is estimated to be ˜30 μm thick. The strands were birefringent and went light and dark upon changing the polarization light with respect to the orientation of the strands. These strands are believed to be nematic domains. These are strikingly similar to lyotropic nematic domains in SWNTs in superacids (termed “SWNT spaghetti”) which were initially thought to be unique (FIG. 19). Aligned super-ropes were achieved from SWNTs spaghetti by extrusion and coagulation through fiber spinning techniques (Ericson, Fan et al., 2004). Thus biphasic silver nanorod dispersions possess great potential to form highly aligned fibers and films. It is to be noted that these tactoids and strand morphology were noticeable only when the silver nanorods were dispersed in ethylene glycol. No such structures were observed when the solvent was water.

4.5.3 Schlieren Structure

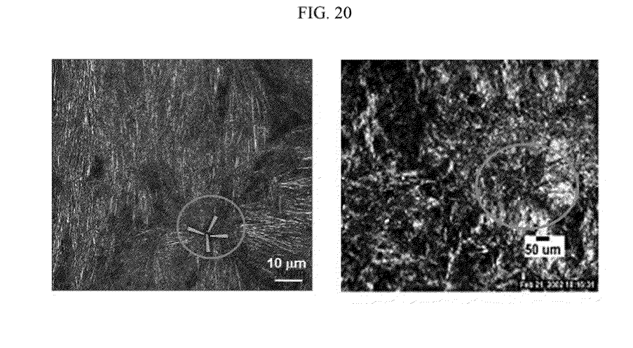

Schlieren structures were discussed in detail in section 2.9.1. These textures arise due to defects in the orientations and are characteristic of a nematic liquid crystal. Such a Schlieren structure was identified in a 0.42 vol % (4 wt %) sample of silver nanorods in ethylene glycol. This was very similar to Schlieren structures identified in the SWNT-superacid nematic phase as shown in FIG. 20. Several closely packed Schlieren structures can be witnessed in thermotropic liquid crystals. This is not seen in liquid crystals with long rigid building blocks. Since the silver nanorods are very long, with their length in microns, their defects or disclinations in orientations are spread out widely similar to SWNTs and MWNTs (Davis, Ericson et al., 2004; Song and Windle 2005).

4.6 Differential Scanning Calorimetry

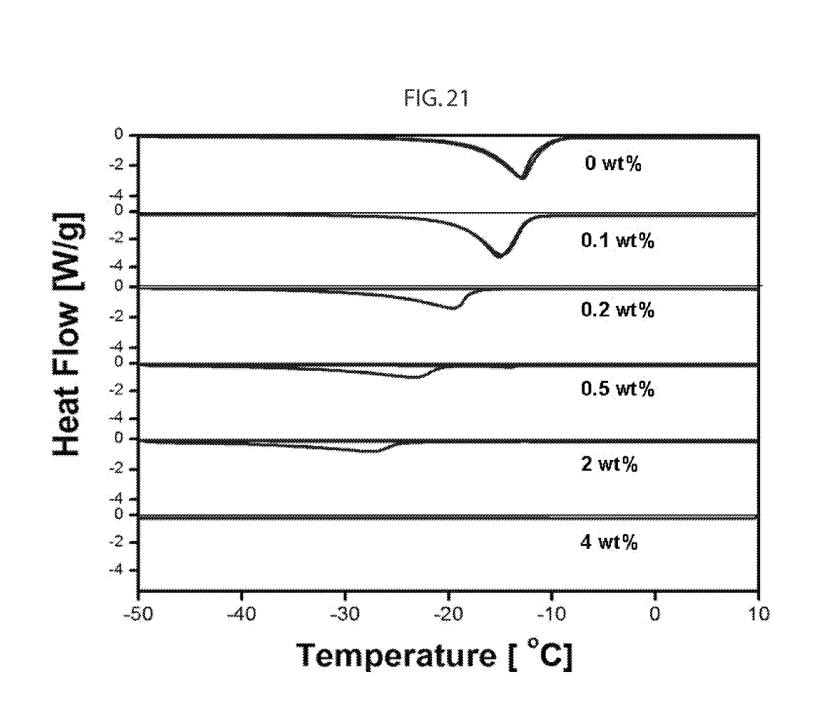

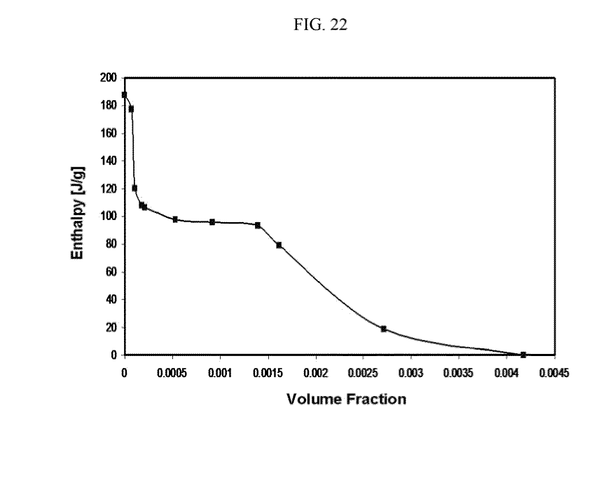

Differential scanning calorimetry (DSC) provides quantitative information about the transition of liquid crystalline phase from isotropic and biphasic concentrations. In liquid crystalline mesophases, the solvent associated with the mesogens also shows ordering and therefore exhibits thermal properties different from free solvent. Inspired by the DSC results of SWNTs in superacid (Zhou, Fischer et al., 2005), DSC was performed on silver nanorods in both ethylene glycol and water. Control samples of ethylene glycol and water were also tested. Remarkable shift in the melting point were exhibited by silver nanorods in ethylene glycol (FIG. 21). A reduction in enthalpy per solvent mass was also observed. Ethylene glycol possessed an enthalpy of 187 J/g. The enthalpy of nanorod dispersions showed a generally decreasing trend with increasing silver nanorod concentration indicating a reduction in the amount of free solvent due to increase in associated solvent. At 4 wt % and more, no heating peak was noticed in the entire temperature range signifying that all the available solvent molecules were associated with nanorods. These changes indicate the presence of two kinds of solvents; the free solvent that had the same thermal properties as that of the bulk solvent and the solvent that was associated with the nanorods that was partly ordered and does not crystalline or melt in the temperature range investigated. Therefore, above 4 wt % (0.42 vol %), the system is completely liquid crystalline. This compares to an Onsager prediction of 4.9 vol % for monodisperse hard rods. This discrepancy is most likely due to the large polydispersity and solvent interactions (Li, Marjanska et al., 2004; Davis 2006). A surprising feature of the enthalpy plot that was not observed for the carbon nanotube liquid crystals is the flat portion of the curve in the biphasic region (FIG. 22). For silver nanorods, differential scanning calorimetry was performed for low isotropic and biphasic concentrations, but this region was not evaluated for SWNTs. Further tests are needed to understand the shape of the curve in the biphasic region. On the other hand, silver nanorods in water did not exhibit significant shift in melting point or a decrease in enthalpy compared to the differential scanning thermogram of water. This clearly indicates the absence of any additional phases of water molecules in aqueous nanorod dispersion. This supports the optical microscopy results of the absence of assembled domains in aqueous dispersions of silver nanorods.

4.7 Shear Alignment

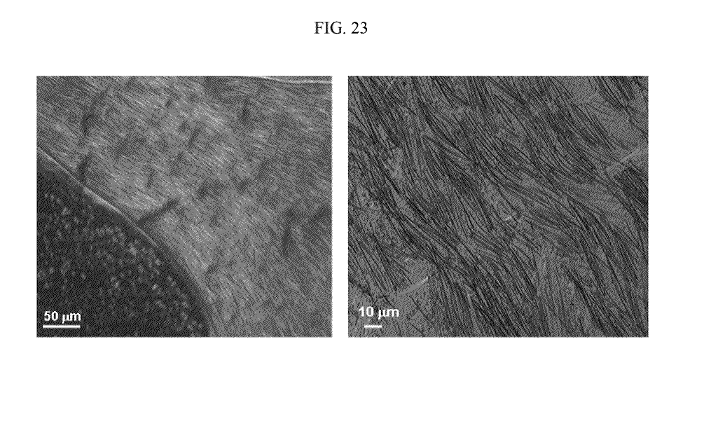

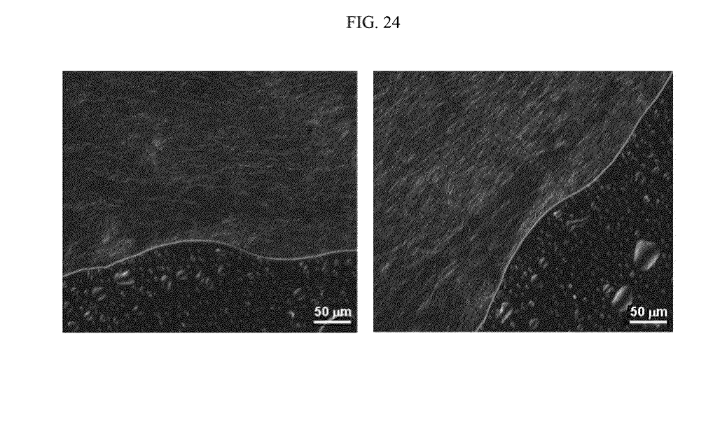

Application of aligned silver nanorods is discussed in Section 2.2.1. Uniform alignment of nanorods on the macroscale is essential for applications in electronic devices and coatings. External fields are often applied to achieve uniform alignment of rods in the entire sample from polydomain samples where nanorods are aligned within the domains but all the domains do not have a common director. Various alignment techniques have been discussed in Section 2.4. Shear forces are particularly attractive since shear is inherent in most fluidic phase processes; in addition shear can cause liquid crystalline domains to align either parallel or perpendicular to the flow direction (Larson 1999). Shear alignment made it possible to get uniformly aligned silver nanorods on a macroscopic scale. Typically, a drop of sample on the glass slide was sheared with a coverslip. Imaging was done after the cessation of shear. Sheared samples resulted in long-range ordering over hundreds of microns both in ethylene glycol and water as shown in FIG. 23. They were highly birefringent and uniformly changed bright and dark as the sample was rotated based on its relative alignment between their director and the polarization vector of the light (FIG. 24). The nanorods remained oriented along the director even after cessation of shear. Shear rate, which is the gradient of velocity in a flowing material, is the ratio of shear velocity to thickness of the sample between the glass slide and coverslip. Typical shear that was applied on samples was around 1000 1/s. Unsheared samples and samples subjected to very low shear (<500 1/s) did not show uniform ordering.

4.7.1 Shear Banding

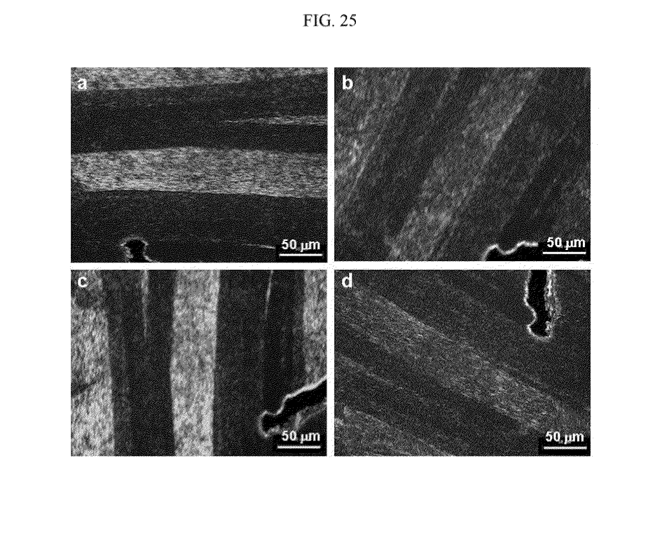

Shear banding was commonly noticed in the samples after the application of shear of 2000 1/s and above (FIG. 25). Banded structures appeared only after the cessation of shear and distance between them varied with sample concentration (Harrison and Navard 1999). For silver nanorod dispersions, the bands appeared bright and dark, with the bright regions predominantly consisting of rods. The nanoparticles were forced out of the thick silver nanorod bands and made up the dark isotropic regions. One theory of shear banding (Section 2.9.1), is that it is prompted by the negative first normal stress difference in rigid rod lyotropic liquid systems (Fischer, Keller et al., 1996; Kiss and S. Porter 1998). Typically within the bands, rods were aligned along the flow direction. However, some samples possessed bands in which the rods are perpendicular to the direction of shear. The latter case has been reported for bands in lyotropic liquid crystalline polymers such as poly(γ-benzyl-L-glutamate) (PBG) and hydroxypeopylcellulose (HPC) (Kiss and S. Porter 1998). Numerical results on shear banding phenomenon on nematic liquids have been proposed recently (M. Gregory Forest, Sebastian Heidenreich et al., 2008). Most notably, direction of orientation can be varied in different planes.

4.8 Aligned Films

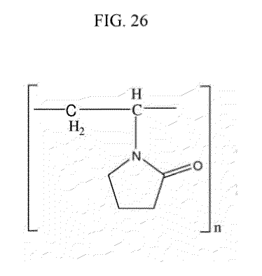

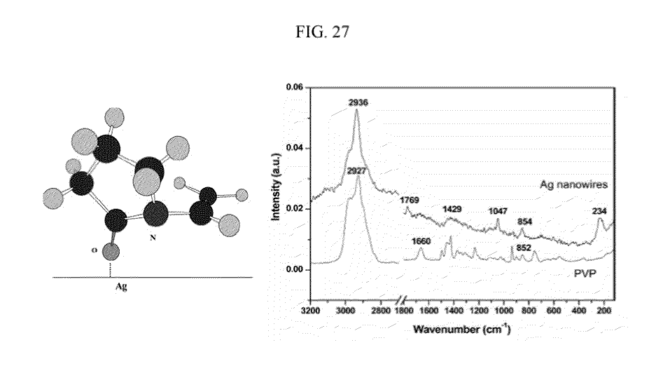

Aligned silver nanorod films have potential application in sensors, antibacterial and antireflective coatings, as discussed in Section 2.2. Shear alignment of nanorods leads to highly aligned macroscale films. Polarized resonant Raman spectroscopy has also been reported to verify the alignment of silver nanorods on a substrate (Yang, Xiong et al., 2006). This is because the intensities of the samples are highly dependent on angle of polarization between nanorod axis and the direction of the electric field vector. During the polyol reduction synthesis, a monolayer coating of polyvinyl pyrrolindone (FIG. 26) takes place on the surface of the silver nanorods (Aroca, Goulet et al., 2005). The Fourier Transform Raman Spectrum (FT-Raman) reported for silver nanorods synthesized using PVP as a capping agent indicated the pyrollidone molecules to be tilted on the surface of the silver nanorod (Gao, Jiang et al., 2004). Furthermore, Gou et al. compared the spectrum of silver nanorods with pure PVP (FIG. 27). The various stretching vibration at 233, 854 and 2936 cm⁻¹ confirmed that the coordination of PVP molecules to the silver surface was through the non bonding electrons of the oxygen atoms in the carbonyl group. Also, the polymer was wrapped irregularly around the rigid rod instead of making a uniform covering.

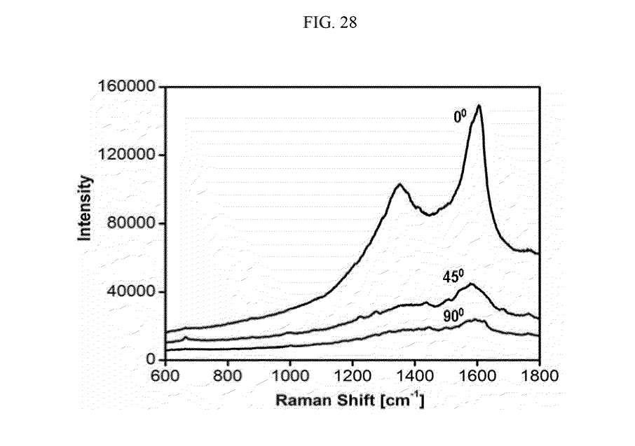

In this research, shear dried silver nanorod coatings exhibited a polarization-dependant optical response clearly confirming aligned films. The maximum peak intensity of PVP enhanced by silver nanorods, was observed when the polarization was parallel to the minor axis of the nanorods and polarization perpendicular to the minor axis of nanorods showed minimum peak intensity at 1600 cm⁻¹ (FIG. 28). The alignment ratio from Raman was determined to be 7:1. No peaks were observed on glass slide without nanorods.

4.9 Antibacterial Studies

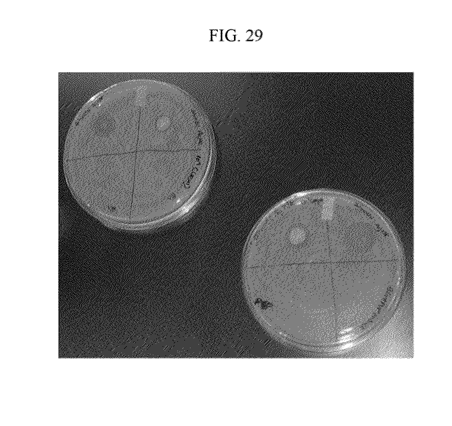

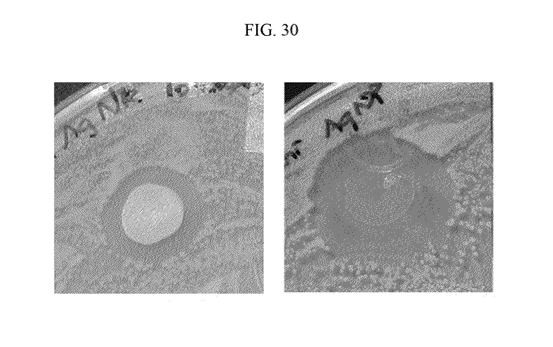

Silver has been employed since ancient times as an antibacterial agent (J. L. Clement and Jarrett 1994). It is well established that the extremely small size of silver nanoparticles exhibit enhanced antibacterial properties compared to bulk silver (Lok, Ho et al., 2007; Krutyakov, Kudrinskiy et al., 2008). Bacterial cell death by silver nanoparticles is mostly due to destruction of cell transport nutrients, weakening of the cell membrane and cytoplasm, and disruption of cell division and proliferation processes. It was also suggested that the disruption of cell membrane morphology by silver ions will cause significant increase in permeability leading to uncontrolled transport through the plasma membrane that causes cell lysis (Sondi and Salopek-Sondi 2004). In order to test for antibacterial properties of PVP capped silver nanorods, gram negative bacteria, E. Coli was incubated with 0.2 mg of silver nanorods, 0.2 mg of silver nanoparticles, along with control samples of ethylene glycol and 0.05 M PVP in ethylene glycol for 24 hours. Areas supplemented with silver nanorods and nanoparticles were entirely clear of bacteria compared to negative controls as shown in FIG. 29 and FIG. 30. The dependence of antibacterial property on the shape of the silver nanoparticle was reported by Pal et al., and surfactant coated silver nanoparticles exhibited better antibacterial properties than silver nanorods when tested on gram negative bacterial, E. coli (Sukdeb Pal, Yu Kyung Tak et al., 2007). Accordingly, it was observed that PVP capped silver nanoparticles displayed a larger area of bacterial clearance than silver nanorods. This is due to the difference in surface areas as the nanoparticles had a larger diameter than the nanorods. Developing growth curves with both nanorods and nanoparticles will lead to detailed characterization of shape dependant antimicrobial studies.

5.1 Conclusions

A microwave assisted polyol reduction silver nanorod synthesis technique was optimized to get a high yield of 8 mg/ml of silver nanorods and nanoparticles in 3.5 minutes. Centrifugation techniques enabled partial separation of nanorods from spherical nanoparticles. Further optimization of isopynic centrifugation parameters such as speed, time and concentration of density gradient may enable complete separation. In spite of the presence of spheres, lyotropic liquid crystalline phases of silver nanorods in ethylene glycol were achieved at approximately 0.4 vol % (4 wt %). Remarkable morphologies such as tactoids and strands, which were strikingly similar to crystal solvates and carbon nanotube liquid crystals, were also characterized in the biphasic region. Schlieren structures, identified at high concentration, provided further confirmation of a nematic phase. Liquid crystallinity and the biphasic-nematic phase transition were determined in ethylene glycol by optical microscopy and differential scanning calorimetry.

By applying shear, uniform alignment of silver nanorods was achieved both in organic and aqueous solvents. Application of shear resulted in shear banding; a phenomenon that has been studied for polymer systems. Aligned macroscale films were prepared by shear coating glass microscopy slides and removing the solvent. They were found to have a relative alignment of 7:1 as measured by Raman spectroscopy. Preliminary rheological studies showed that further studies have the potential to enable further understanding of shear bands and flow alignment. Preliminary studies were also carried out to verify the antibacterial properties of the PVP coated silver nanorods.

This work, using silver as a model system, has laid the foundation for coupled assembly and flow alignment of other systems of inorganic nanorods. Aligned nanorods have great potential for use in many applications including sensors, solar panels, multifunctional materials, and high strength fibers. In addition, the observations of shear banding in the silver nanorod-ethylene glycol system demonstrate that shear banding of nanorod dispersions may enable a new paradigm in the three dimensional bottom-up assembly of nanorods.

### Example 2

### Germanium Nanowire Dispersion

Germanium nanowires with hexene-treated surfaces were produced by the super critical fluid-liquid-solid (SFLS) synthesis technique (Hanrath and Korgel 2004). The nanowires had an average diameter of 7-25 nm after synthesis. After dispersion in solvent, they existed as individuals and aggregates from 7 to 60 nm in diameter. Ge nanowire lengths ranged from less than 2 microns to nearly 10 microns.

Dispersions of germanium nanowire dispersions ranging in initial concentration from volume fraction φ˜1×10⁻⁶ to 1×10⁻⁶) were prepared in methanol, 1-propanol, and chloroform (assuming GE density o=5.33 g/cm³). Dispersions were prepared by several methods including heating (below the solvent boiling point ˜75° C. for methanol) and stirring with a magnetic stirbar for hours to days, with intermittent bath sonication for 30 seconds to 2 minutes at a time. Additional methods included bath sonication for 2 minutes followed by placing on a bottle roller for 2 to 3 days. Samples can be further concentrated by evaporation after mixing in order to increase the fraction of liquid crystalline domains.

### REFERENCES

Ajayan, P. M. and S. Iijima (1993). “Capillarity-induced filling of carbon nanotubes.” Nature 361(6410): 333-334.

Alekseeva, A. V., V. A. Bogatyrev, L. A. Dykman, B. N. Khlebtsov, L. A. Trachuk, A. G. Melnikov and N. G. Khlebtsov (2005). “Preparation and optical scattering characterization of gold nanorods and their application to a dot-immunogold assay.” Applied Optics 44(29): 6285-6295.

Appell, D. (2002). “Nanotechnology: Wired for success.” Nature 419(6907): 553-555.

Arnold, M. S., A. A. Green, J. F. Hulvat, S. I. Stupp and M. C. Hersam (2006). “Sorting carbon nanotubes by electronic structure using density differentiation.” Nature Nanotechnology 1(1): 60-65.

Aroca, R. F., P. J. G. Goulet, D. S. dosSantos, R. A. Alvarez-Puebla and O. N. Oliveira (2005). “Silver Nanowire Layer-by-Layer Films as Substrates for Surface-Enhanced Raman Scattering.” Analytical Chemistry 77(2): 378-382.

Aslan, K., J. R. Lakowicz and C. D. Geddes (2005). “Metal-enhanced fluorescence using anisotropic silver nanostructures: critical progress to date.” Analytical and Bioanalytical Chemistry 382(4): 926-933.

Atkinson, W. I. (2004). Nanocosm: Nanotechnology and the Big Changes Coming from the Inconceivabley Small, AMACOM.

Baughman, R. H., A. A. Zakhidov and W. A. de Heer (2002). “Carbon nanotubes—the route toward applications.” Science 297(5582): 787-792.

Bergin, S. D., V. Nicolosi, S. Giordani, A. d. Gromard, L. Carpenter, W. J. Blau and J. N. Coleman (2007). “Exfoliation in ecstasy: liquid crystal formation and concentration-dependent debundling observed for single-wall nanotubes dispersed in the liquid drug & gamma;-butyrolactone.” Nanotechnology 18(45): 455705.

Boistelle, R. and J. P. Astier (1988). “Crystallization mechanisms in solution.” Journal of Crystal Growth 90(1-3): 14-30.

Buhro, W. E. and V. L. Colvin (2003). “Semiconductor nanocrystals—Shape matters.” Nature Materials 2(3): 138-139.

Buining, P. A., A. P. Philipse and H. N. W. Lekkerkerker (1994). “Phase Behavior of Aqueous Dispersions of Colloidal Boehmite Rods.” Langrnuir 10(7): 2106-2114.

Buitenhuis, J., L. N. Donselaar, P. A. Buining, A. Stroobants and H. N. W. Lekkerkerker (1995). “Phase Separation of Mixtures of Colloidal Boehmite Rods and Flexible Polymer.” Journal of Colloid and Interface Science 175(1): 46-56.

Butler, P. (1999). “Shear induced structures and transformations in complex fluids.” Current Opinion in Colloid & Interface Science 4(3): 214-221.

Caswell, K. K., C. M. Bender and C. J. Murphy (2003). “Seedless, Surfactantless Wet Chemical Synthesis of Silver Nanowires.” Nano Letters 3(5): 667-669.

Chandrasekhar, S. (1992). Liquid Crystals. Cambridge, University Press. Cheng, C., R. K. Gonela, Q. Gu and D. T. Haynie (2005). “Self-Assembly of Metallic Nanowires from Aqueous Solution.” Nano Letters 5(1): 175-178.

Chimentao, R. J., I. Kirm, F. Medina, X. Rodriguez, Y. Cesteros, P. Salagre and J. E. Sueiras (2004). “Different morphologies of silver nanoparticles as catalysts for the selective oxidation of styrene in the gas phase.” Chemical Communications(7): 846-847.

Christian, P., F. Von der Kammer, M. Baalousha and T. Hofmann (2008). “Nanoparticles: structure, properties, preparation and behaviour in environmental media.” Ecotoxicology 17(5): 326-343.

Davidson, P., P. Batail, J. C. P. Gabriel, J. Livage, C. Sanchez and C. Bourgaux (1997). “Mineral liquid crystalline polymers.” Progress in Polymer Science 22(5): 913-936.

Davidson, P. and J.-C. P. Gabriel (2005). “Mineral liquid crystals.” Current Opinion in Colloid & Interface Science 9(6): 377-383.

Davis, V. (2006). Phase Behavior and Rheology of Single-Walled Carbon Nanotubes (SWNTs) in Superacids with Application to Fiber Spinning Chemical and Biomolecular Engineering. Houston, Rice University. PhD.

Davis, V. A., L. M. Ericson, A. N. G. Parra-Vasquez, H. Fan, Y. Wang, V. Prieto, J. A. Longoria, S. Ramesh, R. K. Saini, C. Kittrell, W. E. Billups, W. W. Adams, R. H. Hauge, R. E. Smalley and M. Pasquali (2004). “Phase Behavior and Rheology of SWNTs in Superacids.” Macromolecules 37(1): 154-160.

Dessombz, A., D. Chiche, P. Davidson, P. Panine, C. Chaneac and J. P. Jolivet (2007). “Design of Liquid-Crystalline Aqueous Suspensions of Rutile Nanorods: Evidence of Anisotropic Photocatalytic Properties.” Journal of American Chemical Society 129(18): 5904-5909.

Diesselhorst. H, Freundlich. H and Leonard. B (1915). Elster-Geitel-Fortschrift 453.

Doi, M. and S. F. Edwards (1986). The Theory of Polymer Dynamics. Oxford, Oxford University Press.

Donald, A., A. Windle and S. Hanna (2005). Liquid Crystalline Polymers, Cambridge University Press.

Drexler, K. E. (1986). Engines of Creation: The Coming Era of Nanotechnology Knopf Publishing Group.

Duggal, R., F. Hussain and M. Pasquali (2006). “Self-Assembly of Single-Walled Carbon Nanotubes into a Sheet by Drop Drying.” Advanced Materials 18(1): 29-34.

El-Sayed, M. A. (2001). “Some Interesting Properties of Metals Confined in Time and Nanometer Space of Different Shapes.” Accounts of Chemical Research 34(4): 257-264.

Ericson, L. M., H. Fan, H. Peng, V. A. Davis, W. Zhou, J. Sulpizio, Y. Wang, R. Booker, J. Vavro, C. Guthy, A. N. G. Parra-Vasquez, M. J. Kim, S. Ramesh, R. K. Saini, C. Kittrell, G. Lavin, H. Schmidt, W. W. Adams, W. E. Billups, M. Pasquali, W.-F. Hwang, R. H. Hauge, J. E. Fischer and R. E. Smalley (2004). “Macroscopic, Neat, Single-Walled Carbon Nanotube Fibers.” Science 305(5689): 1447-1450.

Feynman, R. P. (1992). “There's plenty of room at the bottom Microelectromechanical Systems, Journal of 1(1): 60-66.

Fischer, H., A. Keller and A. H. Windle (1996). “The origin of banded textures induced by shear—a suggested scheme and a relevant rheological effect.” Journal of Non-Newtonian Fluid Mechanics 67: 241-268.

Flory, P. J. (1956). “Phase Equilibria in Solutions of Rod-Like Particles.” Proceedings of the Royal Society of London, Ser. A, 234: 73-89.

Flory, P. J. and G. Ronca (1979). “Theory of Systems of Rodlike Particles: II. Thermotropic systems with orientation-dependent interactions.” Molecular Crystals and Liquid Crystals 54: 311-330.

Gao, Y., P. Jiang, D. F. Liu, H. J. Yuan, X. Q. Yan, Z. P. Zhou, J. X. Wang, L. Song, L. F. Liu, W. Y. Zhou, G. Wang, C. Y. Wang, S. S. Xie, J. M. Zhang and D. Y. Shen (2004). “Evidence for the Monolayer Assembly of Poly(vinylpyrrolidone) on the Surfaces of Silver Nanowires.” J. Phys. Chem. B 108(34): 12877-12881.

Ghezelbash, A., B. Koo and B. A. Korgel (2006). “Self-Assembled Stripe Patterns of CdS Nanorods.” Nano Letters 6(8): 1832-1836.

Gleeson, J. T., R. G. Larson, D. W. Mead, G. Kiss and P. E. Cladis (1992). “Image analysis of shear-induced textures in liquid-crystalline polymers.” Liquid Crystals 11(3): 341-364.

Gou, L. F., M. Chipara and J. M. Zaleski (2007). “Convenient, rapid synthesis of Ag nanowires.” Chemistry of Materials 19(7): 1755-1760.

Graff, A., D. Wagner, H. Ditlbacher and U. Kreibig (2005). “Silver nanowires.” The European Physical Journal D—Atomic, Molecular, Optical and Plasma Physics 34(1): 263-269.

Han, Y. J., J. M. Kim and G. D. Stucky (2000). “Preparation of Noble Metal Nanowires Using Hexagonal Mesoporous Silica SBA-15.” Chemistry of Materials 12(8): 2068-2069.

Harrison, P. and P. Navard (1999). “Investigation of the band texture occurring in hydroxypropylcellulose solutions using rheo-optical, Theological and small angle light scattering techniques.” Rheologica Acta 38(6): 569-593.

Haynes, C. L., A. D. McFarland and R. P. Van Duyne (2005). “Surface-enhanced Raman spectroscopy.” Analytical Chemistry 77(17): 338A-346A.

Haynes, C. L., C. R. Yonzon, X. Y. Zhang and R. P. Van Duyne (2005). “Surface-enhanced Raman sensors: early history and the development of sensors for quantitative biowarfare agent and glucose detection.” Journal of Raman Spectroscopy 36(6-7): 471-484.

Heimenz, P. C. and R. Rajagopalan (1997). Principles of Colloid and Surface Chemistry, Marcel Dekker Inc.

Hu, X. H. and C. T. Chan (2004). “Photonic crystals with silver nanowires as a near-infrared superlens.” Applied Physics Letters 85(9): 1520-1522.

Huang, J. Y., S. Chen, Z. Q. Wang, K. Kempa, Y. M. Wang, S. H. Jo, G. Chen, M. S. Dresselhaus and Z. F. Ren (2006). “Superplastic carbon nanotubes.” Nature 439(7074): 281-281.

Huang, Y., C. Y. Chiang, S. K. Lee, Y. Gao, E. L. Hu, J. D. Yoreo and A. M. Belcher (2005). “Programmable Assembly of Nanoarchitectures Using Genetically Engineered Viruses.” Nano Letters 5(7): 1429-1434.

Huang, Y., X. Duan, Q. Wei and C. M. Lieber (2001). “Directed Assembly of One-Dimensional Nanostructures into Functional Networks.” Science 291(5504): 630-633.

Islam, M. F., A. M. Alsayed, Z. Dogic, J. Zhang, T. C. Lubensky and A. G. Yodh (2004). “Nematic Nanotube Gels.” Physical Review Letters 92(8): 088303.

J. L. Clement and P. S. Jarrett (1994). “Antibacterial Silver.” Metal Based Drugs 1(5): 467-482.

Jana, N. R. (2003). “Nanorod shape separation using surfactant assisted self-assembly.” Chemical Communications(15): 1950-1951.

Jana, N. R., L. A. Gearheart, S. O. Obare, C. J. Johnson, K. J. Edler, S. Mann and C. J. Murphy (2002). “Liquid crystalline assemblies of ordered gold nanorods.” Journal of Materials Chemistry 12(10): 2909-2912.

Jeanmaire, D. L. and R. P. Vanduyne (1977). “Surface Raman Spectroelectrochemisty .1. Heterocyclic, Aromatic, And Aliphatic-Amines Adsorbed On Anodized Silver Electrode.” Journal of Electroanalytical Chemistry 84(1): 1-20.

Jeong, D. H., Y. X. Zhang and M. Moskovits (2004). “Polarized surface enhanced Raman scattering from aligned silver nanowire rafts.” Journal of Physical Chemistry B 108(34): 12724-12728.

Jin, S., D. Whang, M. C. McAlpine, R. S. Friedman, Y. Wu and C. M. Lieber (2004). “Scalable Interconnection and Integration of Nanowire Devices without Registration.” Nano Letters 4(5): 915-919.

Johnson, B. F. G. (2003). “Nanoparticles in Catalysis.” Topics in Catalysis 24(1): 147-159.

Khokhlov, A. R. (1991). Theories Based on the Onsanger Approach. Liquid Crystallinity in Polymers. A. Ciferri. New York, VCH Publishers: 97-129.

Kim, F., S. Kwan, J. Akana and P. Yang (2001). “Langmuir-Blodgett Nanorod Assembly.” Journal of American Chemical Society 123(18): 4360-4361.

Kiss, G. and R. S. Porter (1998). Mechanical and Thermophysical Properties of Polymer Liquid Crystals. London, Chapman & Hall.

Krutyakov, Y. A., A. A. Kudrinskiy, A. Y. Olenin and G. V. Lisichkin (2008). “Synthesis and properties of silver nanoparticles: Achievements and prospects.” Uspekhi Khimii 77(3): 242-269.

Larhed, M. and A. Hallberg (2001). “Microwave-assisted high-speed chemistry: a new technique in drug discovery.” Drug Discovery Today 6(8): 406-416.

Larson, R. G. (1999). The Structure and Rheology of Complex Fluids. New York, Oxford University Press.

Lee, S. W., B. M. Wood and A. M. Belcher (2003). “Chiral smectic C structures of virus-based films.” Langmuir 19(5): 1592-1598.

Lekkerkerker, H. N. W. and A. Stroobants (1998). “Colloids: Ordering entropy.” Nature 393(6683): 305-307.

Li, L. S. and A. P. Alivisatos (2003). “Semiconductor nanorod liquid crystals and their assembly on a substrate.” Advanced Materials 15(5): 408-+.

Li, L. S., M. Marjanska, G. H. J. Park, A. Pines and A. P. Alivisatos (2004). “Isotropic-liquid crystalline phase diagram of a CdSe nanorod solution.” Journal of Chemical Physics 120(3): 1149-1152.

Li, L. S., J. Walda, L. Manna and A. P. Alivisatos (2002). “Semiconductor nanorod liquid crystals.” Nano Letters 2(6): 557-560.

Li, Q., Y. T. Zhu, I. A. Kinloch and A. H. Windle (2006). “Self-Organization of Carbon Nanotubes in Evaporating Droplets.” J. Phys. Chem. B 110(28): 13926-13930.

Lin, S. W., J. Yue and A. Gedanken (2001). “Synthesis of long silver nanowires from AgBr nanocrystals.” Advanced Materials 13(9): 656-658.

Liu, F.-K., Y.-C. Chang, P.-W. Huang, F.-H. Ko and T.-C. Chu (2004). “Preparation of Silver Nanorods by Rapid Microwave Heating.” Chemistry Letters 33(8): 1050-1051.

Loeffler, J. (2005). “Overview on Promising Nanomaterials for Industrial Applications.” Nanomaterial Roadmap 2015.

Lok, C. N., C. M. Ho, R. Chen, Q. Y. He, W. Y. Yu, H. Sun, P. K. H. Tam, J. F. Chiu and C. M. Che (2007). “Silver nanoparticles: partial oxidation and antibacterial activities.” Journal of Biological Inorganic Chemistry 12(4): 527-534.

M. Gregory Forest, Sebastian Heidenreich, Siegfried Hess, Xiaofeng Yang and R. Zhou (2008). “Robustness of pulsating jet-like layers in sheared nano-rod dispersions.” in preparation.

Martin, A. B. and F. Daan (1998). “Influence of polydispersity on the phase behavior of colloidal liquid crystals: A Monte Carlo simulation study.” Journal of Chemical Physics 109(14): 6193-6199.

Mazzola, L. (2003). “Commercializing nanotechnology. ” Nat Biotech 21(10): 1137-1143.

Meuer, S., P. Oberle, P. Theato, W. Tremel and R. Zentel (2007). “Liquid Crystalline Phases from Polymer-Functionalized TiO2 Nanorods.” Advanced Materials 19(16): 2073-2078.

Mingos, D. M. P. and D. R. Baghurst (1991). “Applications of Microwave Dielectric Heating Effects to Synthetic Problems in Chemistry” Chemical Society Reviews 20(1): 1-47.

Moulton, S. E., M. Maugey, P. Poulin and G. G. Wallace (2007). “Liquid Crystal Behavior of Single-Walled Carbon Nanotubes Dispersed in Biological Hyaluronic Acid Solutions.” Journal of American Chemical Society 129(30): 9452-9457.

Muller, J. A., R. S. Stein and H. H. Winter (1994). “Director Dynamics of Uniformly Aligned Nematic Liquid-Crystals in Transient Shear-Flow” Rheologica Acta 33(6): 473-484.

Muller, J. A., R. S. Stein and H. H. Winter (1996). “Rotation of liquid crystalline macromolecules in shear flow and shear-induced periodic orientation patterns.” Rheologica Acta 35(2): 160-167.

Müller, R. H., M. Radtke and S. A. Wissing (2002). “Solid lipid nanoparticles (SLN) and nanostructured lipid carriers (NLC) in cosmetic and dermatological preparations.” Advanced Drug Delivery Reviews 54(Supplement 1): S131-S155.

Mulvaney, P. (1996). “Surface Plasmon Spectroscopy of Nanosized Metal Particles.” Langmuir 12(3): 788-800.

Murphy, C. J. and N. R. Jana (2002). “Controlling the Aspect Ratio of Inorganic Nanorods and Nanowires.” Advanced Materials 14(1): 80-82.

Nadagouda, M. N. and R. S. Varma (2008). “Green synthesis of Ag and Pd nanospheres, nanowires, and nanorods using vitamin B-2: Catalytic polymerisation of aniline and pyrrole.” Journal of Nanomaterials.

Nanobills. (2003). “108 Congress 1st Session.”

Onsager, L. (1949). “The Effects of Shape on the Interaction of Colloidal Particles.” Annals of the New York Academy of Sciences 51: 627-659.

Orendorff, C. J., P. L. Hankins and C. J. Murphy (2005). “pH-triggered assembly of gold nanorods.” Langmuir 21(5): 2022-2026.

Pang, Y. T., G. W. Meng, Q. Fang and L. D. Zhang (2003). “Silver nanowire array infrared polarizers.” Nanotechnology 14(1): 20-24.

Park, K. (2006). Synthesis, Characterization, and Self-Assembly of Size Tunable Gold Nanorods. Polymer, Textile and Fiber Engineering. Atlanta, Ga. Institute of Technology. PhD.

S. Badaire, C. Zakri, M. Maugey, A. Derré, J. N. Barisci, G. Wallace and P. Poulin (2005). “Liquid Crystals of DNA-Stabilized Carbon Nanotubes.” Advanced Materials 17(13): 1673-1676.

Scalia, G., C. von Buhler, C. Hagele, S. Roth, F. Giesselmann and J. P. F. Lagerwall (2008). “Spontaneous macroscopic carbon nanotube alignment via colloidal suspension in hexagonal columnar lyotropic liquid crystals.” Soft Matter 4(3): 570-576.

Shanmukh, S., L. Jones, J. Driskell, Y. P. Zhao, R. Dluhy and R. A. Tripp (2006). “Rapid and sensitive detection of respiratory virus molecular signatures using a silver nanorod array SERS substrate.” Nano Letters 6(11): 2630-2636.

Somoza, A. M., C. Sagui and C. Roland (2001). “Liquid-crystal phases of capped carbon nanotubes.” Physical Review B 63(8): 081403.

Sondi, I. and B. Salopek-Sondi (2004). “Silver nanoparticles as antimicrobial agent: a case study on E-coli as a model for Gram-negative bacteria.” Journal of Colloid and Interface Science 275(1): 177-182.

Song, W., I. A. Kinloch and A. H. Windle (2003). “Nematic Liquid Crystallinity of Multiwall Carbon Nanotubes.” Science 302(5649): 1363-.

Song, W. and A. H. Windle (2005). “Isotropic-Nematic Phase Transition of Dispersions of Multiwall Carbon Nanotubes.” Macromolecules 38(14): 6181-6188.

Sonin, A. S. (1998). “Inorganic lyotropic liquid crystals.” Journal of Materials Chemistry 8(12): 2557-2574.

Speranza, A. and P. Sollich (2003). “Isotropic-nematic phase equilibria in the Onsager theory of hard rods with length polydispersity.” Physical Review E 67(6): 061702.

Straley, J. P. (1973). “Third Virial-Coefficient for Gas of Long Rods.” Molecular Crystals and Liquid Crystals 24(1-2): 7-20.

Sukdeb Pal, Yu Kyung Tak and J. M. Song (2007). “Does the Antibacterial Activity of Silver Nanoparticles Depend on the Shape of the Nanoparticle? A Study of the Gram-Negative Bacterium Escherichia coli.” Applied and Environmental Microbiology 73(6): 1712-1720.

Sun, Y. and Y. Xia (2002). “Shape-Controlled Synthesis of Gold and Silver Nanoparticles.” Science 298(5601): 2176-2179.

Sun, Y., Y. Yin, B. T. Mayers, T. Herricks and Y. Xia (2002). “Uniform Silver Nanowires Synthesis by Reducing AgNO3 with Ethylene Glycol in the Presence of Seeds and Poly(Vinyl Pyrrolidone).” Chemistry of Materials 14(11): 4736-4745.

Sun, Y. G. and Y. N. Xia (2002). “Large-scale synthesis of uniform silver nanowires through a soft, self-seeding, polyol process.” Advanced Materials 14(11): 833-837.

T. H. Han, J. Kim, J. S. Park, C. B. Park, H. Ihee and S. O. Kim (2007). “Liquid Crystalline Peptide Nanowires.” Advanced Materials 19(22): 3924-3927.

Tanase, M., L. A. Bauer, A. Hultgren, D. M. Silevitch, L. Sun, D. H. Reich, P. C. Searson and G. J. Meyer (2001). “Magnetic Alignment of Fluorescent Nanowires.” Nano Letters 1(3): 155-158.

Tsuji, M., M. Hashimoto, Y. Nishizawa, M. Kubokawa and T. Tsuji (2005). “Microwave-assisted synthesis of metallic nanostructures in solution.” Chemistry-a European Journal 11(2): 440-452.

Vroege, G. J., D. M. E. Thies-Weesie, A. V. Petukhov, B. J. Lemaire and P. Davidson (2006). “Smectic liquid-crystalline order in suspensions of highly polydisperse goethite nanorods.” Advanced Materials 18(19): 2565-2568.

Wang, Z. H., J. W. Liu, X. Y. Chen, J. X. Wan and Y. T. Qian (2004). “A simple hydrothermal route to large-scale synthesis of uniform silver nanowires.” Chemistry-a European Journal 11(1): 160-163.

Y. Xia, P. Yang, Y. Sun, Y. Wu, B. Mayers, B. Gates, Y. Yin, F. Kim and H. Yan (2003). “One-Dimensional Nanostructures: Synthesis, Characterization, and Applications.” Advanced Materials 15(5): 353-389.

Yang, Y., L. M. Xiong, J. L. Shi and M. Nogami (2006). “Aligned silver nanorod arrays for surface-enhanced Raman scattering.” Nanotechnology 17(10): 2670-2674.

Yu, G. H., A. Y. Cao and C. M. Lieber (2007). “Large-area blown bubble films of aligned nanowires and carbon nanotubes.” Nature Nanotechnology 2(6): 372-377.

Zakri, C. and P. Poulin (2006). “Phase behavior of nanotube suspensions: from attraction induced percolation to liquid crystalline phases.” Journal of Materials Chemistry 16(42): 4095-4098.

Zhou, W., J. E. Fischer, P. A. Heiney, H. Fan, V. A. Davis, M. Pasquali and R. E. Smalley (2005). “Single-walled carbon nanotubes in superacid: X-ray and calorimetric evidence for partly ordered H2SO4.” Physical Review B 72(4).

Zhu, J., S. Liu, O. Palchik, Y. Koltypin and A. Gedanken (2000). “Shape-Controlled Synthesis of Silver Nanoparticles by Pulse Sonoelectrochemical Methods.” Langmuir 16(16): 6396-6399.
Zocher. H and Torok. C (1960). Kolloid Z 173: 1.
Zocher. H and Torok. C (1962). Kolloid Z 180: 41.

In the foregoing description, certain terms have been used for brevity, clearness, and understanding. No unnecessary limitations are to be implied therefrom beyond the requirement of the prior art because such terms are used for descriptive purposes and are intended to be broadly construed. The different configurations, systems, and method steps described herein may be used alone or in combination with other configurations, systems, and method steps. It is to be expected that various equivalents, alternatives and modifications are possible within the scope of the appended claims. The aforementioned references are incorporated herein by reference in their entireties.

We claim:

1. A composition comprising a dispersion of aligned inorganic nanocylinders in lyotropic liquid crystalline form, wherein the nanocylinders have an average diameter of about 1-100 nm and an average length of about 1-100 microns.

2. The composition of claim 1, wherein at least about 5% of the inorganic nanocylinders are in lyotropic liquid crystalline form.

3. The composition of claim 1, wherein the inorganic nanocylinders have an aspect ratio of at least about 5.

4. The composition of claim 1, wherein the inorganic nanocylinders have an aspect ratio of at least about 50.

5. The composition of claim 1, wherein the inorganic nanocylinders are silver nanocylinders.

6. The composition of claim 1, wherein the inorganic nanocylinders are germanium nanocylinders.

7. The composition of claim 1, prepared by a method comprising:
(a) forming a dispersion of the inorganic nanocylinders in a solvent;
(b) placing the dispersion on a solid substrate; and
(c) applying a shear force to the dispersion thereby aligning the inorganic nanocylinders.

8. The composition of claim 7, wherein the inorganic nanocylinders are silver and the solvent is an aqueous solution that includes surfactant or a biomolecule.

9. The composition of claim 7, wherein the inorganic nanocylinders are silver and the solvent is a polyol.

10. The composition of claim 7, wherein the polyol is ethylene glycol or propylene glycol.

11. The composition of claim 7, wherein the inorganic nanocylinders are germanium and the solvent is an alcohol.

12. The composition of claim 11, wherein the alcohol is ethanol, propanol, or isopropanol.

13. The composition of claim 7, wherein the inorganic nanocylinders are germanium and the solvent is chloroform.

14. The composition of claim 1, wherein the nanocylinder dispersions exhibit shear banding.

15. A method for preparing a coated substrate, the method comprising:
(a) forming a dispersion of inorganic nanocylinders in a solvent;
(b) placing the dispersion on the solid substrate; and
(c) applying a shear force to the dispersion thereby aligning the inorganic nanocylinders.

16. The method of claim 15, further comprising drying the solvent.

17. The method of claim 15, wherein the inorganic nanocylinders are silver and the solvent is an aqueous solution.

18. The method of claim 15, wherein the inorganic nanocylinders are silver and the solvent is a polyol.

19. The method of claim 15, wherein the polyol is ethylene glycol or propylene glycol.

20. The method of claim 15, wherein the inorganic nanocylinders are germanium and the solvent is an alcohol.

21. The method of claim 20, wherein the alcohol is ethanol, propanol, or isopropanol.

22. The method of claim 15, wherein the inorganic nanocylinders are germanium and the solvent is chloroform.

23. The method of claim 15, wherein the inorganic nanocylinders are silver and the method further comprises synthesizing the inorganic nanocylinders prior to step (a) by heating a mixture comprising silver salt and a polyol solvent.

24. The method of claim 23, wherein the mixture is heated in a microwave.
